(19) United States
(12) Patent Application Publication
(10) Pub. No.: US 2007/0050329 A1
(43) Pub. Date: Mar. 1, 2007

(54) Storage system and storage apparatus

(76) Inventors: Takashi Chikusa, Odawara (JP); Masami Mori, Hiratsuka (JP); Hironori Nakama, Odawara (JP); Masashi Yukawa, Odawara (JP); Takehiro Maki, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/256,928

(22) Filed: Oct. 25, 2005

(30) Foreign Application Priority Data
Aug. 29, 2005 (JP) 2005-248152

(51) Int. Cl. G06F 17/30

(52) U.S. Cl. 707/2

(57) ABSTRACT

A storage system has a host system and a storage apparatus. The storage apparatus includes a first volume and a second volume to store files transmitted from the host system. The host system has: a display unit for displaying the content of a first directory in the first volume and the content of a corresponding second directory in the second volume; and a switching unit for switching, on the display unit, between the display showing the content of the first directory and the display showing the content of the second directory. The storage apparatus further has: a searching unit for searching for the second directory based on a table having a migration path from a root directory to the first directory in the first volume stored therein; and a transmitting unit for transmitting the content of the second directory, which is searched for by the searching unit, to the host system.

### CROSS-REFERENCES TO RELATED APPLICATIONS

This application relates to and claims priority from Japanese Patent Application No. 2005-248152, filed on Aug. 29, 2005, the entire disclosure of which is incorporated herein by reference.

### BACKGROUND OF THE INVENTION

The present invention relates to a storage system and a storage apparatus and is preferably applied to a storage system structured including storage apparatus(s) having snapshot and volume replication functions.

Data backup functions have been conventionally known, such as the snapshot function of storing images, that are originally stored in a primary volume as of at a certain point in time, in a sub volume in a considerably short period of time, and the volume replication function of copying all file data in the primary volume and storing it in the sub volume.

For example, Japanese Patent Laid-open (Kokai) Publication No. 2002-278819 suggests, as a disk array apparatus having the snapshot function, a disk array apparatus that stores snapshot images of the primary volume as of at a certain point in time in the sub volume; stores data which is updated after storing the snapshot images in other volumes; and reads a specified snapshot image based on the snapshot images and updated data.

Conventional disk array apparatuses require cumbersome operations and enormous time to search the sub volume for a file that corresponds to a specified file in a primary volume because, in conventional disk array apparatuses, the sub volume can be accessed only as a separate volume from the primary volume.

Moreover, conventional disk array apparatuses have problems in that a user cannot easily compare lower directories and file data in a specified directory in the primary volume and lower directories and file data in the corresponding directory in the sub volume and judge at a glance whether or not any of the lower directories or file data has been updated.

With today's trend toward rapid increase of storage capacity in single disk array apparatuses, and compliance regulations, file data management has become more difficult because of the ever-increasing amount of file data accumulated in disk array apparatuses.

The present invention has been devised considering the above aspects and it aims to provide a storage system and a storage apparatus that enables easy file management.

### SUMMARY OF THE INVENTION

In order to solve the above problems, the present invention provides a storage system having a host system and a storage apparatus. The storage apparatus has a first volume and a second volume to store files transmitted from the host system. The host system includes: a display unit for displaying the content of a first directory in the first volume and the content of a corresponding second directory in the second volume; and a switching unit for switching between the display showing the content of the first directory and the display showing the content of the second directory on the display unit. The storage apparatus further has: a searching unit for searching for the second directory based on a table having a migration path from a root directory to the first directory in the first volume stored therein; and a transmitting unit for transmitting the content of the second directory, which is searched for by the searching unit, to the host system.

Accordingly, simply by switching via the switching unit, it is possible to switch, on the display unit, between the display showing the content of the first directory in the first volume and the display showing the content of the second directory in the second volume using the similarities between the first volume and the second volume. Therefore, a user can easily see the specific content of the first directory in the first volume in the content of the corresponding second directory in the second volume.

The present invention also provides a storage apparatus having a first volume and a second volume to store files transmitted from a host system. The storage apparatus has: a searching unit for searching for a second directory based on a table having a migration path from a root directory to a first directory in the first volume stored therein; and a transmitting unit for transmitting the content of the second directory searched for by the searching unit to the host system.

Consequently, simply by switching via the switching unit, the display showing the content of the first directory in the first volume and the display showing the content of the second directory in the second volume can be switched on the display unit using the similarities between the first volume and the second volume. Therefore, a user can easily see the specific content of the first directory in the first volume in the content of the corresponding second directory in the second volume.

The present invention further provides a storage system having a host system and a storage apparatus. The storage apparatus has a first volume and a second volume to store files transmitted from the host system. The host system has: a display unit for displaying a third directory and/or a first file one level lower than a first directory in the first volume, or, a fourth directory and/or a second file one level lower than a second directory in the second volume, the third directory corresponding to the first directory; and a switching section shown on the display unit for switching from the display showing the third directory and/or the first file one level lower than the first directory to the display showing the fourth directory and/or the second file one level lower than the second directory. The storage apparatus further includes: a managing unit for managing a first node tree where file nodes for the files and directory nodes for the directories in the first volume are arranged in a hierarchy tree; and a second node tree where file nodes and directory nodes in the second volume are arranged in a hierarchy tree; a migration path storing unit for storing directory nodes of each level from a first root node to the first directory node in the first node tree, the directory nodes being on the migration path; and a control unit by which, when switching is performed externally via the switching section displayed on the display unit, a second directory node is searched for in the second node tree based on the directory nodes stored in the migration path storing unit and a fourth directory node and/or second file node one level lower than the second directory node are transmitted to the host system.

Accordingly, simply by switching via the switching unit, the display showing the content of the first directory in the first volume and the display showing the content of the second directory in the second volume can be switched on the display unit using the similarities between the first volume and the second volume. Therefore, a user can easily see the specific content of the first directory in the first volume in the content of the second directory in the second volume.

According to the present invention, it is possible to switch, on the display unit, between the display showing the content of the first directory in the first volume and the display showing the content of the second directory in the second volume using the similarities between the first volume and the second volume, simply by switching via the switching unit. Therefore, the user can easily see the specific content of the first directory in the first volume in the content of the second directory in the second volume. In other words, the present invention can realize a storage system and a storage apparatus that enables improvement of simple operation and easy management of files.

### BRIEF DESCRIPTION OF THE DRAWINGS

FIG. 1 A is a front view of a conceptual diagram of the external structure of a storage system according to embodiments of the present invention.

FIG. 1 B is a rear view of a conceptual diagram of the external structure of the storage system according to the embodiments of the present invention.

FIG. 2 is a block diagram showing the structure of a storage system according to Embodiment 1.

FIG. 3 is a block diagram showing the structure of an information processing apparatus according to Embodiment 1.

FIG. 4 is a conceptual diagram schematically showing a display window.

FIG. 5 is another conceptual diagram schematically showing the display window.

FIG. 6 is a conceptual diagram schematically showing a node tree list of a primary volume.

FIG. 7 is a conceptual diagram schematically showing a node tree list of a sub volume.

FIG. 8 A-F are conceptual diagrams schematically showing a migration path storage table.

FIG. 9 and FIG. 10 are a part of a flowchart showing a first display control processing routine.

FIG. 11 is a flowchart schematically showing a node tree switching processing routine.

FIG. 12 is a conceptual diagram schematically showing a node tree list of the updated primary volume.

FIG. 13 A-C are conceptual diagrams schematically showing a migration path storage table.

FIG. 14 is a conceptual diagram schematically showing node tree switching processing.

FIG. 15 A-C are conceptual diagrams schematically showing a migration path temporary storage table.

FIG. 16 is a block diagram showing the structure of a storage system according to Embodiments 2 and 3.

FIG. 17 is a block diagram showing the structure of an information processing apparatus according to Embodiments 2 and 3.

FIG. 18-FIG. 21 are conceptual diagrams, each function explained later, schematically showing a display window.

FIG. 22 and FIG. 23 are a part of a flowchart showing a second display control processing routine.

FIG. 24 and FIG. 25 are a part of a flowchart showing a node information transmission processing routine.

FIG. 26 is a flowchart showing a node information filtering processing routine.

FIG. 27 is a conceptual diagram schematically showing a node information temporary storage table.

FIG. 28 is a conceptual diagram schematically showing a display window.

FIG. 29 is another conceptual diagram schematically showing the display window.

FIG. 30 is a flowchart showing a third display control processing routine.

FIG. 31 is another flowchart showing the third display control processing routine.

FIG. 32 is a flowchart showing a node information migration processing routine.

FIG. 33 is a block diagram showing the structure of a storage system according to another embodiment.

FIG. 34 A is a conceptual diagram schematically showing a display window according to the other embodiment.

FIG. 34 B is a another conceptual diagram schematically showing a display window according to the other embodiment.

FIG. 35 is a conceptual diagram schematically showing a display window according to still another embodiment.

### DETAILED DESCRIPTION OF THE INVENTION

Embodiments of this invention are described below in detail with reference to the attached drawings.

### 1. Embodiment 1

1-1. Storage System External Structure

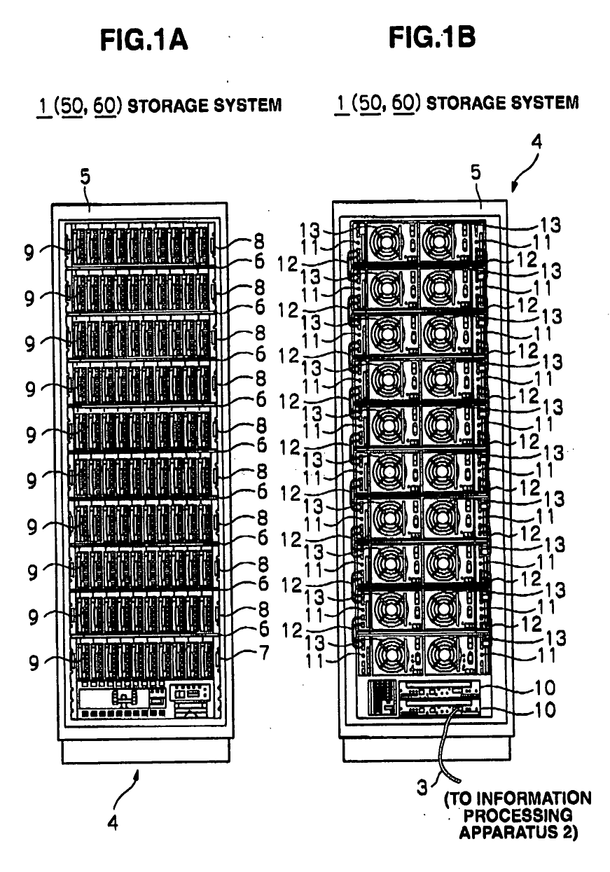

FIG. 1 A and B show the external structure of a storage system 1 according to Embodiment 1, where a plurality of information processing apparatuses 2 is connected to a disk array apparatus 4 via a network cable 3 such as a Local Area Network (LAN) or a World Area Network (WAN).

A frame rack 5 of the disk array apparatus 4 has mount frames 6 formed therein, making a plurality of levels at specified vertical intervals. A basic chassis 7 and expanded chassis 8, together constituting the disk array apparatus 4, are placed in the mount frames 6 so that they fit into the spaces in the rack and can be drawn out like drawers.

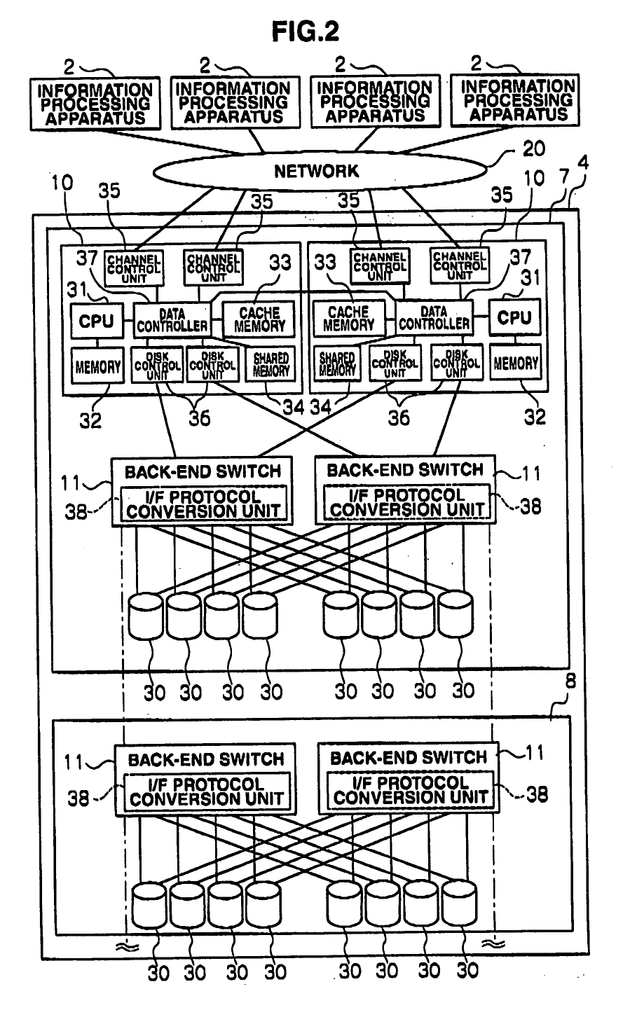

The basic chassis 7 is arranged on the bottom-most level of the frame rack 5. As shown in FIG. 1 A, at the upper front side of the basic chassis 7, a plurality of hard disk drive units 9 having hard disk drives 30 (FIG. 2) mounted therein is placed side by side.

The basic chassis 7 also has, at the bottom-right back side, a plurality of disk controllers 10 for controlling the disk array apparatus 4, as shown in FIG. 1 B. In the present storage system 1, the information processing apparatuses 2 are connected to the disk controllers 10 via the network cable 3.

The basic chassis 7 further has, at the upper-right and upper-left back sides, back-end switches 11. In the disk array apparatus 4, the plural disk controllers 10 are connected via a connection cable 12, which is based on a specified communication interface such as Fibre Channel, to the back-end switches 11, which are also internally connected to the hard disk drive units 9.

The basic chassis 7 also has, in the upper-back center area, a plurality of air-cooling fans 13 for taking air into the basic chassis 7 and expelling the heat generated at the hard disk drive units 9.

The expanded chassis 8 are placed on the levels above the basic chassis 7. Each expanded chassis 8 has, at the front side, plural disk drive units 9 arranged side by side in the same manner as in the basic chassis 7, as shown in FIG. 1 A.

Each expanded chassis 8 also has, at the right and left back sides, back-end switches 11, just like the basic chassis 7. In the disk array apparatus 4, the back-end switches 11 of the basic chassis 7 are connected via the connection cable 12 to those of the expanded chassis 8, the back-end switches 11 of the expanded chassis 8 being also internally connected to the hard disk drive units 9 therein.

In each expanded chassis 8, a plurality of air-cooling fans 13 is also arranged in the back side center area in the same manner as in the basic chassis 7.

Incidentally, where the disk array apparatus 4 has two or more expanded chassis 8 arranged therein, the back-end switches 11 of one expanded chassis 8 are connected to that of the other expanded chassis 8, which is placed one level higher than the first expanded chassis 8, via the connection cable 12. The disk array apparatus 4 is structured by serially connecting the basic chassis 7 and the expanded chassis 8 to one another.

Embodiment 1 has been described for the case where dual redundancy is provided by the disk controllers 10, back-end switches 11 and the air-cooling fans 13 of the basic chassis 7 as well as the back-end switches 11 and the air-cooling fans 13 of the expanded chassis 8 in order to ensure the reliability of the disk array apparatus 4. However, the basic chassis 7 and each expanded chassis 8 may also have only one or more of the respective elements.

1-2. Storage System Internal Structure

The internal structure of the present storage system 1 is described below. FIG. 2 shows the internal structure of the storage system 1 where the plural information processing apparatuses 2 are connected to the disk array apparatus 4 via a network such as a LAN or a WAN.

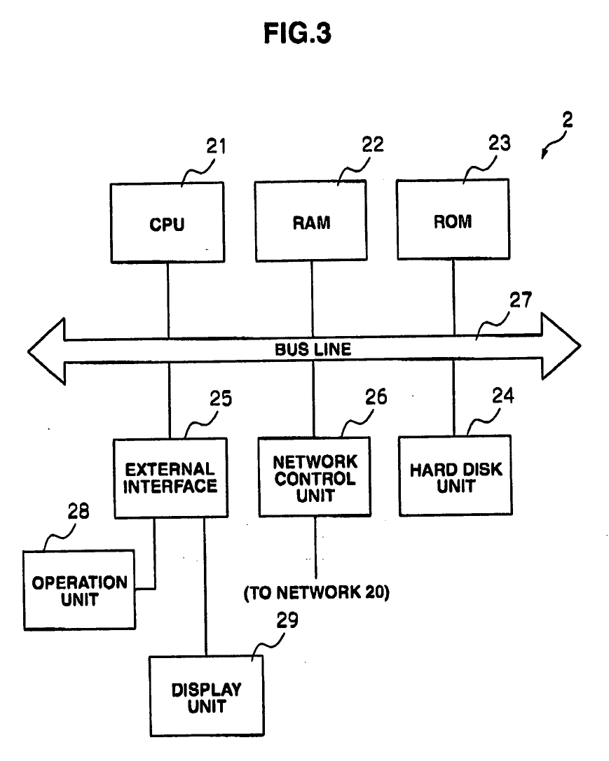

FIG. 3 shows the specific structure of an information processing apparatus 2. The information processing apparatus 2 is structured as a host computer, such as a personal computer, a work station, or a mainframe computer. The information processing apparatus 2 has a structure where a central processing unit (CPU) 21, a read only memory (ROM) 22 having various programs stored therein, a Random Access Memory (RAM) 23 as a work memory for the CPU 21, a hard disk unit 24 having various application software stored therein, an external interface unit 25, and a network control unit 26 are connected one another via a bus line 27.

An operation unit 28 consisting of a keyboard and a pointing device or similar, and a display unit 29 are connected to the external interface unit 25.

The CPU 21 in the information processing apparatus 2 runs, in the RAM 22, various control programs, application software, operating systems, and a display window W₁ control program, which will be described later, stored in the ROM 23 and the hard disk unit 24.

The CPU 21 in the information processing apparatus 2 performs various processing by running the application software, operating systems and control programs that are run in the RAM 22. Specifically, guided by a user operating the operation unit 28, the CPU 21 in the information processing apparatus 2 transmits write requests and write target file data to the disk array apparatus 4, or transmits read requests to the disk array apparatus 4 and receives read target file data therefrom. The information processing apparatus 2 is configured to transmit and receive file-level access requests (write requests and read requests) as well as write request and write target file data.

Moreover, the CPU 21 in the information processing apparatus 2, guided by the user operating the operation unit 28, displays on the display unit 29 a directory/file display window W₁, which will be described later, and one-level-lower directories and files in the current directory using various graphical user interfaces (GUIs).

As described above, the disk array apparatus 4 is structured by serially connecting the basic chassis 7 and the plural expanded chassis 8. As already mentioned, the basic chassis 7 is structured having the plural disk controllers 10, back-end switches 11, and the hard disk drives 30.

Each disk controller 10 includes a CPU 31, a memory 32, a cache memory 33, a shared memory 34, a plurality of channel control units 35, a plurality of disk control units 36, and a data controller 37.

The data controller 37 is configured with, for example, a bus or a switch such as a crossbar switch for transmitting data by high-speed switching, and is connected to the CPU 31, cache memory 33, shared memory 34, channel control units 35, and the disk control units 36.

The data controller 37 transfers access requests and file data between the CPU 31, cache memory 33, shared memory 34, channel control units 35, and disk control units 36. The data controller 37 is also connected another data controller 37 to enable communication and the transmission of access requests and file data therebetween.

Each of the channel control units 35 is configured as a micro computer system having a micro processor (not shown in the drawing), an internal memory (not shown in the drawing), and communication interface(s), and is assigned a network address (for example, a Media Access Control (MAC) address, a World Wide Name (WWN), or an Internet Protocol (IP) address) for identifying itself. Incidentally, where there are plural information processing apparatuses 2, the channel control units 35 accept access requests from respective information processing apparatuses 2.

The channel control units 35 transfer: access requests transmitted from the information processing apparatuses 2 to the shared memory 34 to store; and file data of a write target file transmitted from the information processing apparatus 2 to the cache memory 33 to store. Moreover, they also read file data of a read target file data stored in the cache memory 33 to transmit it to the information processing apparatuses 2.

The cache memory 33 and the shared memory 34 are storage memories shared between the channel control units 35 and the disk control units 36.

The cache memory 33 has a data storage area for temporarily storing mainly file data of read/write target files.

The shared memory 34 has: an access request storage area for temporarily storing mainly access requests; and a control information storage area for storing management information for managing file data of/read target files stored in the hard disk drives 30 and control information used in programs.

The memory 32 is a storage memory used by the CPU 31 and has a control information storage area for storing Network Attached Storage (NAS) control information, which is information for controlling the disk controller 10 as a NAS controller.

According to the NAS control information stored in the memory 32, the CPU 31 in the disk array apparatus 4 controls the disk controller 10 as a NAS controller and converts, for example, file-level access requests stored in the shared memory 34 into block-level access requests.

The CPU 31 in the disk array apparatus 4 also converts, for example, file data of a write target file formed at a file-access level and stored in the cache memory 33 into file data of a write target file formed at block-access level.

The CPU 31 further converts file data of a read target file formed at the block-access level and stored in the cache memory 33 into file data of a write target file formed at a file-access level.

Each disk control unit 36 is configured as a micro computer system having a micro processor (not shown in the drawing) and a internal memory (not shown in the drawing) and executes processing such as writing and reading of file data to and from the hard disk drives 30 according to access requests stored in the shared memory 34.

The disk control units 36 are configured to control the hard disk drives 30 at a Redundant Array of Inexpensive Disk (RAID) level regulated by a RAID system.

The back-end switches 11 are for switching data transfer paths for relaying block-level access requests, file data of a write target file formed at a block-access level, and block-level read target file data from the disk control units 36 to destination hard disk drives 30. Each back-end switch 11 may have an I/F protocol conversion unit 38 inside. The I/F protocol conversion unit 38 is configured to be able to convert I/F protocols to I/F protocols supported by the respective hard disk drives 30 when necessary.

The hard disk drives 30 are configured with Advanced technology Attachment (ATA) hard disk drives, Serial-ATA (SATA) hard disk drives, Small Computer System Interface (SCSI) hard disk drives, Serial Attached SCSI (SAS) hard disk drives, or Fibre Channel hard disk drives arranged in arrays.

In the present storage system 1, a combination of plural hard disk drives 30 forms groups (RAID groups or Logical Units (LUs)) managed according to the RAID system. The groups provide storage areas on which one or more logical volumes (hereinafter called the “logical volume(s)”) are set. File data is stored in the logical volumes.

Embodiment 1 has been described for the case where the storage system 1 is equipped with hard disk drives 30, however the present invention is not limited to that case, and various other media such as optical disks, magnetic tapes, and semiconductor memory may be utilised instead. Moreover, in Embodiment 1, all the hard disk drives 30 are of the same type but it is also possible to mix different types of hard disk drives, for example, the case where SATA hard disk drives and SCSI hard disk drives are provided in the same numbers.

Moreover, Embodiment 1 has been described for the case where dual redundancy is provided by the channel control units 35 end the disk control units 36 in order to ensure the reliability of the disk array apparatus 4. However, the present invention is not limited to that case, and a disk controller 10 may also have only one or more of the respective elements.

Furthermore, Embodiment 1 has been described for the case where the channel control units 35 and the disk control units 36 are configured as micro computers, however the present invention is not limited to that case, and they may be structured as extension boards consisting of semiconductor substrates or the like that extend the capabilities of CPUs.

1-3. Display Switching at Information Processing Apparatus 2

Explained below is display switching, which is performed for switching between the display-showing a specified directory in a copy-from (sourced) logical volume (hereinafter called the “primary volume”) VOL_{P} and the display showing a directory in a logical volume created during the snapshot processing (hereinafter called the “sub volume”) VOL_{S} that corresponds to the directory in the primary volume VOL_{P}.

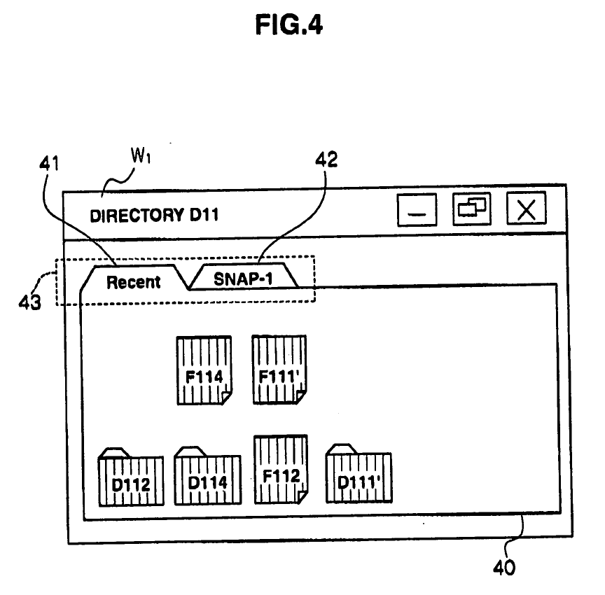

The CPU 21 in an information processing apparatus 2 displays on its display unit 29 a display window W₁ showing, for example, a directory D11; in the primary volume VOL_{P} as shown in FIG. 4.

The display window W₁ has: a low level information display section 40 showing directory(s) and/or file(s) one level lower than the directory D11 and a directory switching section 43 showing a recent tag 41 (Recent) to select the primary volume VOL_{P} and a snapshot tag 42 (SNAP-1) to select the sub volume VOL_{S}. In FIG. 4, the recent tag 41 is selected and files F111′, F112, F114 and directories D111′, D112 and D114 are displayed in the low level information display section 40.

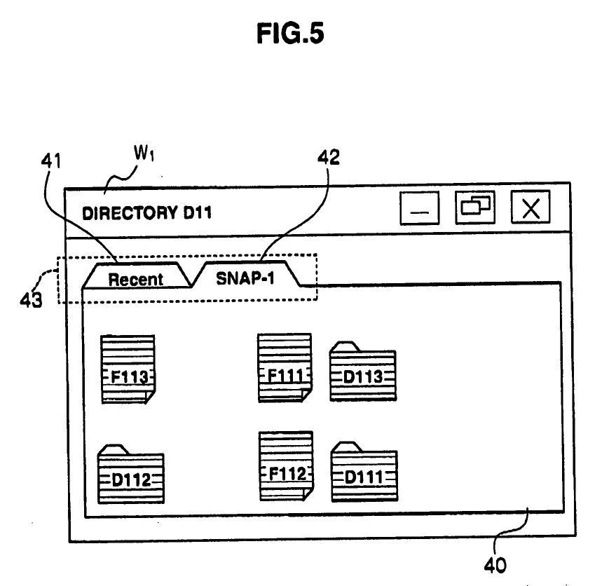

When a user, operating the operation unit 28, then selects the snapshot tag 42, the CPU 21 in the information processing apparatus 2 switches the display from the directory D11 in the primary volume VOL_{P} to the corresponding directory D11 in the sub volume VOL_{S}, as shown in FIG. 5.

In FIG. 5, the snapshot tag 42 is selected in the display window W₁ and the low level information display section 40 shows F111, F112, F113 and directories D111, D112, and D113.

As is clear from FIGS. 4 and 5, the CPU 21 in the information processing apparatus 2 displays the directory D11 in the primary volume VOL_{P} and the corresponding directory D11 in the sub volume VOL_{S} using different directory/file colors so that the user will not confuse them.

Consequently, with the storage system 1, simply by the user using operation unit 28 to switch between the recent tag 41 and the snapshot tag 42 shown in the directory switching section 43, the display showing the directories and/or files one level lower than the directory D11 in the primary volume VOL_{P} and the display showing directories and/or files one level lower than the directory D11 in the sub volume VOL_{S} can be switched using the similarities between a node tree list PNL of the primary volume VOL_{P} and a node tree list SNL of the sub volume VOL_{S}. Accordingly, the user can easily find specified directory(s) and/or file(s) one level lower than the directory D11 in the primary volume VOL_{P} from directory(s) and/or file(s) one level lower than the corresponding directory D11 in the sub volume VOL_{S}.

Moreover, with the storage system 1, the user can easily compare the directory(s) and/or file(s) one level lower than the directory D11 in the primary volume VOL_{P} and those one level lower than the directory D11 in the sub volume VOL_{S} simply by using the operation unit 28 to switch between the recent tag 41 and the snapshot tag 42 shown in the directory switching section 43. Accordingly, the user can easily comprehend the state of the directory(s) and/or file(s).

From the comparison, the user can easily perceive that, in the directory D11 in the primary volume VOL_{P}: the file F111 has been updated to the file F111′; the directory D111 has been updated to the directory D111′: the file F112 and the directory D112 are not updated; the file F113 and the directory D113 have been deleted; and the file F114 and the directory D114 have been newly created since the execution of the snapshot processing.

Embodiment 1 has been described regarding the case where the directory D11 in the primary volume VOL_{P} and that in the sub volume VOL_{S} are displayed using different directory/file colors, however, the present invention is not limited to that case, and various other identification methods can be employed; for example, the primary volume VOL_{P} and the sub volume VOL_{S} may be shown in different colors in the low level information display section 40.

Incidentally, when the user again selects the recent tag 41 through the operation unit 28, the CPU 21 in the information processing apparatus 2 switches from the directory D11 in the sub volume VOL_{S} in FIG. 5 back to the directory D11 in the primary volume VOL_{P} in FIG. 4.

1-4. Display Control Processing

Display control processing, which is conducted to control switching between the display showing a specified directory in the primary volume VOL_{P} and the display showing a corresponding directory in the sub volume VOL_{S} on the display unit 29 in the information processing apparatus 2, is explained.

1-4-1. Node Tree List

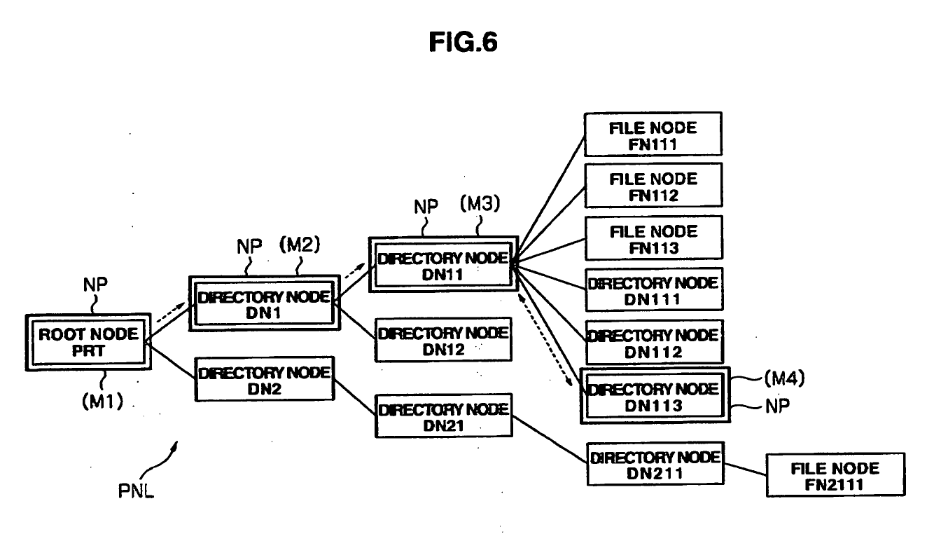

FIG. 6 shows a primary volume VOL_{P} node tree list PNL in an initial state. In the node tree list PNL, nodes for managing directories and files are arranged in a hierarchy tree.

Normally, a node stores information including file name, physical disk address, file type, file size, permission, creation date and time, and modification date and time etc. The node also has the physical disk address information for a node one level higher. There are two types of nodes, a directory node and a file node. A directory node can have lower-level-nodes while a file node cannot.

The node tree list in FIG. 6 illustrates the relationship between the respective nodes. The first node positioned at the beginning of the tree is called the “root node.” One logical volume can usually have one root node.

A logical volume immediately after format has only a root node, and every time a directory or a file is created, a node is added but when a directory or a file is deleted, its node is deleted.

In FIG. 6, the primary volume VOL_{P} node tree list PNL has a root node PRT. The root node PRT is connected to directory nodes DN1 and DN2 one level lower. The directory node DN1 is connected to directory nodes DN11 and DN12 one level lower. The directory node DN11 is connected to file nodes FN111, FN112 and FN113 and directory nodes DN111, DN112 and DN113 one level lower.

Moreover, the directory node DN2 is connected to a directory node DN21. The directory node DN 21 is connected to a directory node DN211. The directory node DN 211 is connected to a file node FN2111.

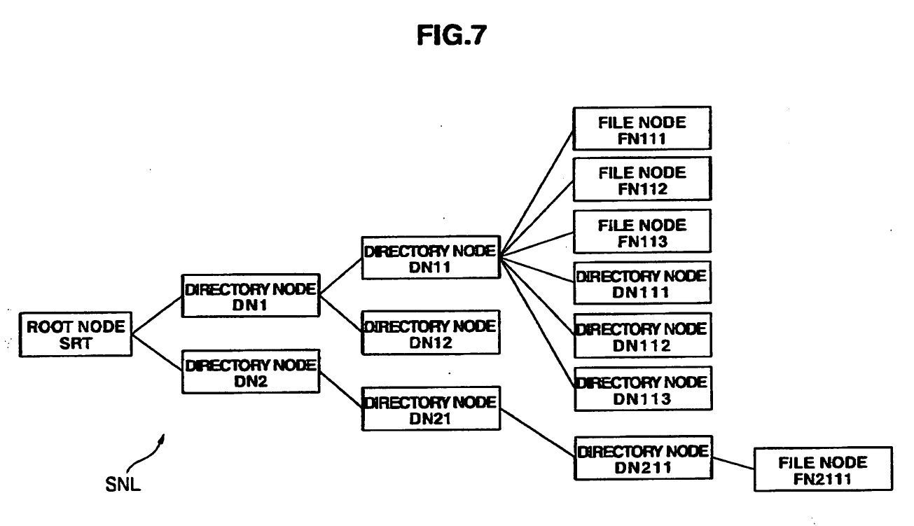

FIG. 7 shows a sub volume VOL_{S} node tree list created in the snapshot processing. This sub volume VOL_{S} node tree list SNL has a root node SRT. In the node tree list SNL, below the root node SRT is a copy of the node tree list PNL.

1-4-2. Migration Path Storage Processing

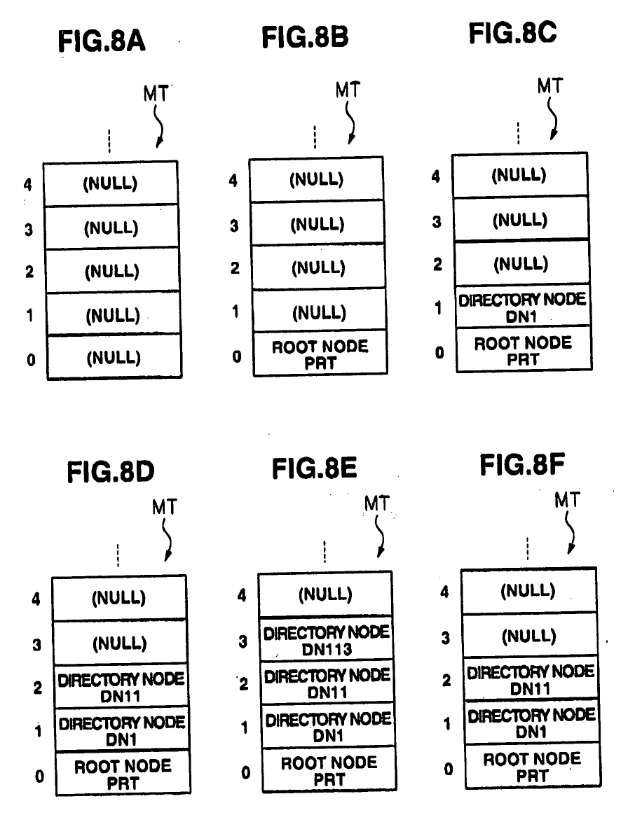

Migration path storage processing performed when a node pointer NP moves from one directory to another is explained. FIG. 8 A shows a migration path memory table MT in an initial state, the migration path memory table being a table for storing a migration path when the node pointer NP moves from one directory to another. When the CPU 31 in the disk array apparatus 4 receives from an information processing apparatus 2 a request for the node information for, for example, the directory D11 in the primary volume VOL_{P}, it reads from the hard disk drives 30 the node tree list PNL as shown in FIG. 6 and puts the node pointer NP, indicating the current node position in the primary volume VOL_{P}, at the root node PRT (FIG. 6 (M1)).

At this time, the CPU 31 in the disk array apparatus 4 stores the node currently pointed to by the node pointer NP—the root node PRT—in a level 0 area in the migration path memory table MT in the memory 32, as shown in FIG. 8 B.

The CPU 31 in the disk array apparatus 4 then searches the node tree list PNL for the target directory node and moves the node pointer NP there. Specifically, after storing the root node PRT in the migration path memory table MT, the CPU 31 moves the node pointer NP from the root node PRT past the directory node DN1 (FIG. 6 (M2)) to the directory DN11 (FIG. 6 (M3)).

As shown in FIG. 8 C, the CPU 31 in the disk array apparatus 4 stores the passed directory node DN1 in the level 1 area in the migration path memory table MT. It then stores the currently pointed-to directory node DN11 in the level 2 area in the migration path memory table MT as shown in FIG. 8 D.

Then, when the CPU 31 in the disk array apparatus 4 receives from the information processing apparatus 2 another user request via the operation unit 28 for the node information for, for example, the directory D113 in the primary volume VOL_{P}, it moves the node pointer NP from the directory node DN11 to the directory node DN113 (FIG. 6 (M4)). Incidentally, node information refers to directory node(s) and/or file node(s). The CPU 31 then stores the currently pointed-to directory node DN113 in the level 3 area in the migration path memory table MT, as shown in FIG. 8 E.

When the CPU 31 in the disk array apparatus 4 further receives from the information processing apparatus 2 another user request via the operation unit 28 for the node information for, for example, the directory DN11 in the primary volume VOL_{P}, it moves the node pointer NP from the directory node DN113 back to the directory node DN11 (FIG. 6 (M3)). At this time, the CPU 31 deletes the directory node DN113 from the level 3 area as show in FIG. 8 F.

1-4-3. Display Control Processing Routine

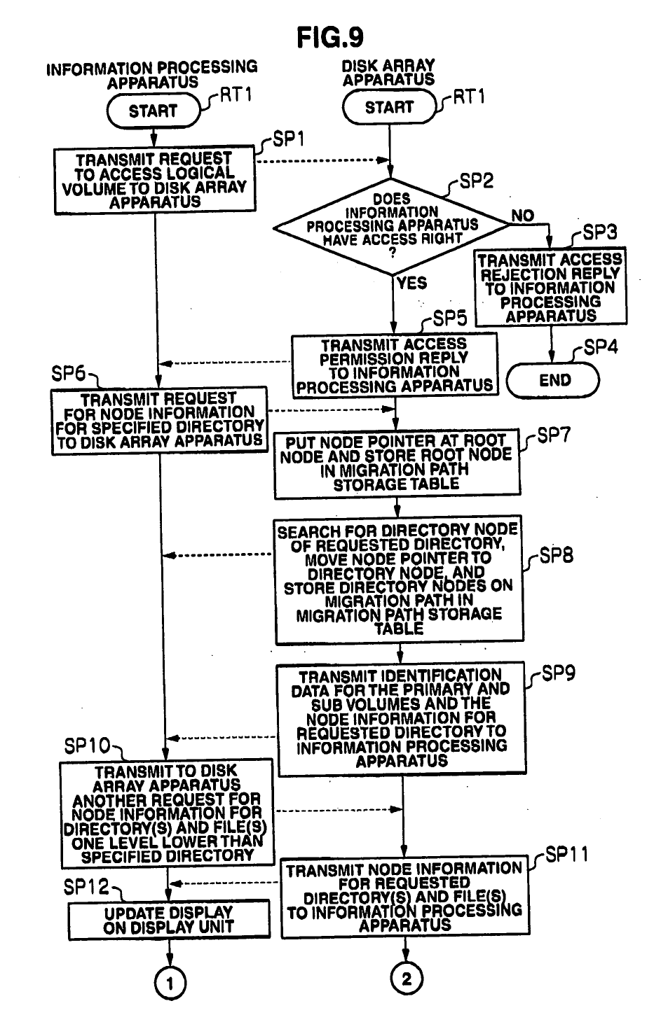

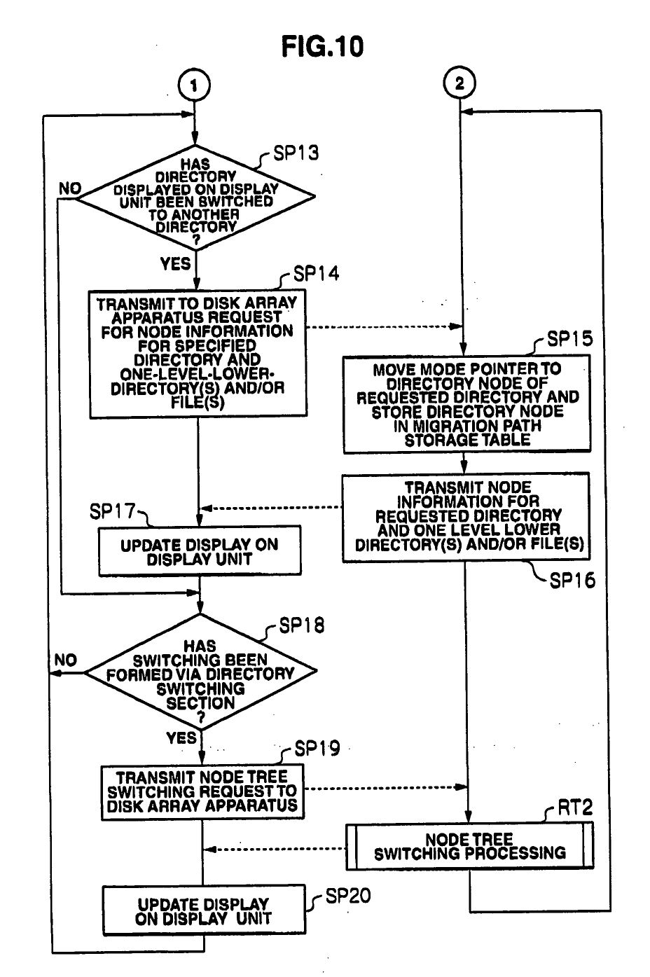

FIGS. 9 and 10 together show a flowchart indicating a specific processing routine for display control processing, which is conducted to control switching between the display showing a specified directory in the primary volume VOL_{P} and the display showing a corresponding directory in the sub volume VOL_{S} on the display unit 29 in an information processing apparatus 2.

In the initial stage, the CPU 21 in the information processing apparatus 2 transmits a request to access the primary volume VOL_{P} to the disk array apparatus 4 according to the first display control processing routine RT1 shown in FIGS. 9 and 10 (SP1).

When the CPU 31 in the disk array apparatus 4 receives that request from the information processing apparatus 2, it checks whether the information processing apparatus 2 has the right to access the primary volume VOL_{P} (SP2).

If the information processing apparatus 2 does not have the right to access the primary volume VOL_{P} (SP2: No), the CPU 31 in the disk array apparatus 4 transmits an access rejection reply to the information processing apparatus 2 (SP3) and terminates the first display control processing routine RT1 (SP4).

If, on the contrary, the information processing apparatus 2 has the right to access the primary volume VOL_{P} (SP2: Yes), the CPU 31 in the disk array apparatus 4 transmits an access permission reply to the information processing apparatus 2 (SP5).

When the CPU 21 in the information processing apparatus 2 receives the access permission reply from the disk array apparatus 4, it transmits, guided by the user via the operation unit 28, a request for the node information for, for example, the directory D11 in the primary volume VOL_{P} to the disk array apparatus 4 (SP6).

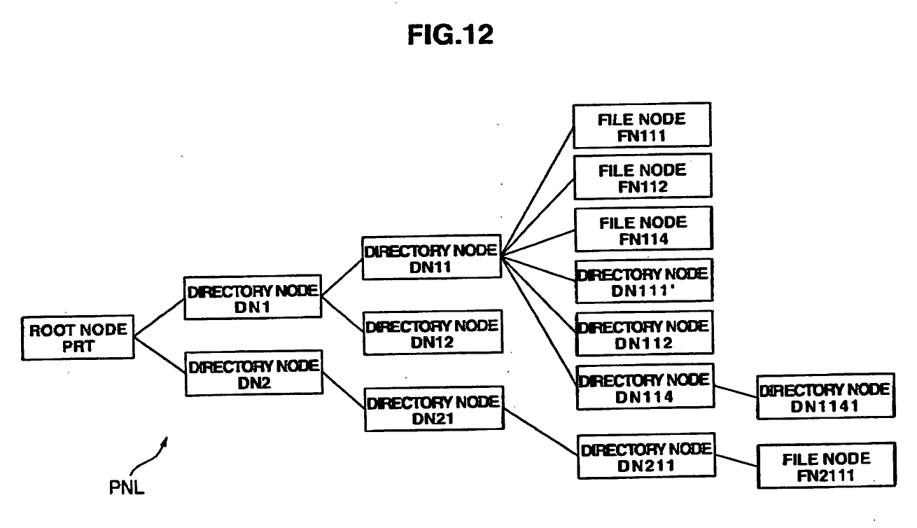

When the CPU 31 in the disk array apparatus 4 receives that request, it reads from the hard disk drives 30 a list of pointers indicating storage locations of the node tree list PNL shown in FIG. 12 and a node tree list SNL, a derivative of the primary volume VOL_{P}.

FIG. 12 shows the node tree list PNL where the directories and files have been updated within a predetermined period of time since the creation of the sub volume VOL_{S} in the snapshot processing.

In the updated node tree list PNL in FIG. 12, the root node PRT is connected to the directory nodes DN1 and DN2 one level lower; the directory node DN1 is connected to the directory nodes DN11 and DN12 one level lower; the directory node DN11 is connected to the file nodes FN111′, FN112 and FN114 and the directory nodes DN111′, DN112 and DN114 one level lower; and the directory node DN114 is connected to a directory node DN1141 one level lower.

Moreover, the directory node DN2 is connected to a directory node DN21; the directory node DN21 is connected to a directory node DN211; and the directory node DN211 is connected to a file node FN2111.

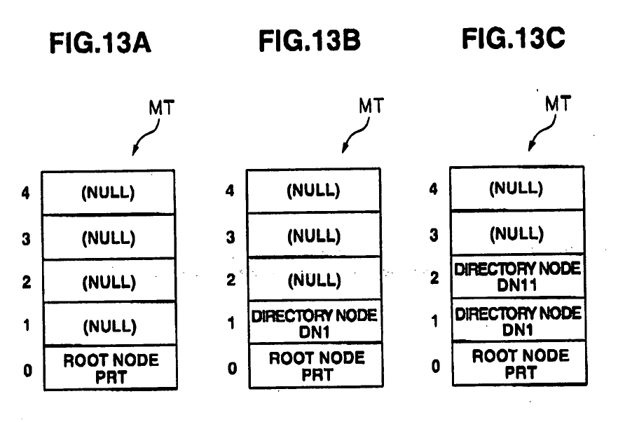

The CPU 31 in the disk array apparatus 4 puts the node pointer NP at the root node PRT in the updated node tree list PNL in FIG. 12 and stores the root node PRT in the migration path memory table MT (SP7) (FIG. 13 A).

Subsequently, the CPU 31 in the disk array apparatus 4 searches the node tree list PNL shown in FIG. 12 for the directory node DN11, moves the node pointer NP from the root node PRT to the directory node DN11, stores the directory node DN1 on the migration path of the node pointer NP in the migration path memory table MT (FIG. 13 B), and stores the currently pointed-to directory node DN11 in the migration path memory table MT (SP8) (FIG. 13 C).

The CPU 31 in the disk array apparatus then transmits, to the information processing apparatus 2, the directory node DN11 and identification data for the primary volume VOL_{P} and the sub volume VOL_{S} necessary to display the directory switching section 43 on the display unit 29 in the information processing unit 2 (SP9). Incidentally, Embodiment 1 has been described for the case where there is only one sub volume VOL_{S} being provided, however the present invention is not limited to that case, and a plurality of sub volumes VOL_{S} may be created.

When the CPU 21 in the information processing apparatus 2 receives the nods information for the directory D11 and the identification data for the primary volume VOL_{P} and the sub volume VOL_{S}, it transmits, to the disk array apparatus 4, another request for the node information for directory(s) and file(s) one level lower than the directory D11 in the primary volume VOL_{P} (SP10).

When the CPU 31 in the disk array apparatus 4 receives that request, it transmits to the information processing apparatus 2 the directory nodes DN111′, DN112 and DN114 and the file nodes FN111′, FN112 and FN114 one level lower than the directory node DN11 in the primary volume VOL_{P} (SP11).

When the CPU 21 in the information processing apparatus 2 receives the node information for the directories D111′, DN112 and DN114 and the files F111′, FN112 and FN114 one level lower than the directory D11 in the primary volume VOL_{P}, it updates the display in the low layer information display section 40 in the display window W₁ on the display unit 29 and displays the directories and files (SP12) (FIG. 4).

Subsequently, the CPU 21 in the information processing apparatus 2 waits until the display on the display unit 29 is switched, guided by the user operating the operation unit 28, from the directory D11 in the primary volume VOL_{P} to, for example, the one-level-higher directory D1 or the one-level-lower directory D111′, D112 or D114 (SP13). Then, if it is switched by the user to, for example, the one-level-lower directory D114, the CPU 21 transmits to the disk array apparatus 4 a request for the node information for the directory 0114 and one-level-lower directory(s) and/or file(s) (SP14).

When the CPU 31 in the disk array apparatus 4 receives that request, it moves the node pointer NP from the directory node DN11 to the directory node DN114 in the node tree list PNL and stores the directory node DN114 in the migration path memory table MT (SP15).

Subsequently, the CPU 31 in the disk array apparatus 4 transmits the directory node DN114 in the primary volume VOL_{P} and the one-level-lower directory node DN1141 to the information processing apparatus 2 (SP16).

When the CPU 21 in the information processing apparatus 2 receives the node information for the one-level-lower directory D1141, it updates the display in the low level information display section 40 in the display window W₁ on the display unit 29 and displays the one-level-lower directory D1141 in the primary volume VOL_{P} (SP17).

Incidentally, when the display on the display unit 29 is switched, guided by the user via the operation unit 2B, from the directory D114 in the primary volume VOL_{P} back to the one-level-higher directory D11, the CPU 21 in the information processing apparatus 2 transmits to the disk array apparatus 4 another request for the node information for the directory DN11 and the one-level-lower directories.

When the CPU 31 in the disk array apparatus 4 receives that request, it deletes the directory node DN114 corresponding to the directory D114 in the primary volume VOL_{P} from the migration path memory table MT.

Subsequently, the CPU 31 in the disk array apparatus 4 transmits the directory nodes DN111′, DN112 and DN114 and the file nodes FN111′, FN112 and FN114 one level lower than the directory node DN11 in the primary volume VOL_{P} to the information processing apparatus 2.

When the CPU 21 in the information processing apparatus 2 receives the node information for the directories D111′, D112 and D114 and the files F111′, F112 and F114 one level lower than the directory D11 in the primary volume VOL_{P}, it updates the display in the low level information display section 40 in the display window W₁ on the display unit 29, and displays the directories and files (FIG. 4).

Thereafter, the CPU 21 in the information processing apparatus 2 waits until, for example, the recent tag 41 is switched to the snapshot tag 42 by the user via the operation unit 28 (SP18). When the user switches from the recent tag 41 to the snapshot tag 42, the CPU 21 in the information processing apparatus 2 transmits a request to switch from the primary volume VOL_{P} node tree to the sub volume VOL_{S} node tree to the disk array apparatus 4 (SP19).

When the CPU 31 in the disk array apparatus 4 receives the node tree switching request from the information processing apparatus 2, it executes node tree switching processing.

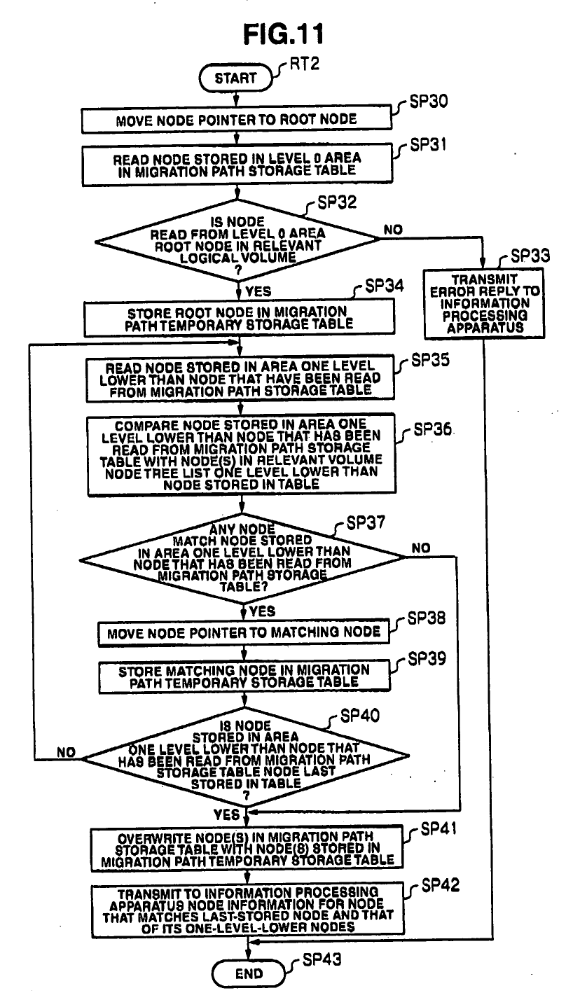

FIG. 11 shows a flowchart indicating a specific processing routine for the node tree switching processing, which is conducted to control switching between the primary volume VOL_{P} node tree and the sub volume VOL_{S} node tree.

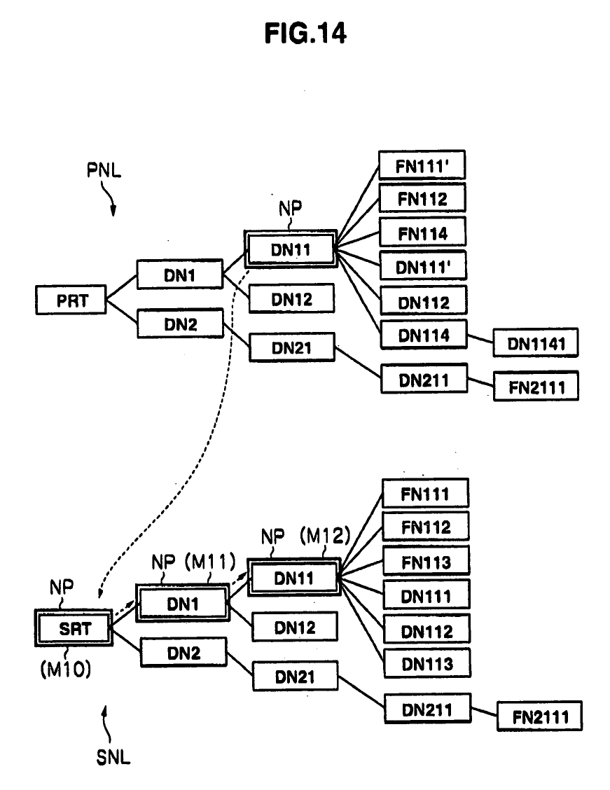

In the initial stage, the CPU 31 in the disk array apparatus 4 moves the node pointer NP from the currently pointed to directory node DN11 in the node tree list PNL shown in FIG. 12 to the root node SRT in the node tree list SNL according to a node tree switching processing routine RT2 (SP30) (FIG. 14 (M10)).

Subsequently, the CPU 31 in the disk array apparatus 4 reads the node stored in the level 0 area in the migration path memory table MT in the memory 32 (SP31). Specifically, in the present example, the root node PRT stored in the level 0 area in the migration path memory table MT is read.

Then, the CPU 31 in the disk array apparatus 4 checks whether the node stored in the level 0 area in the migration path memory table MT is the root node PRT of the primary volume VOL_{P} (SP32).

If the node stored in the level 0 area in the migration path memory table MT is not the root node PRT of the primary volume VOL_{P} (SP32: No), the CPU 31 in the disk array apparatus 4 transmits an error reply to the information processing apparatus 2 (SP33) and terminates the node tree switching processing routine RT2 (SP43).

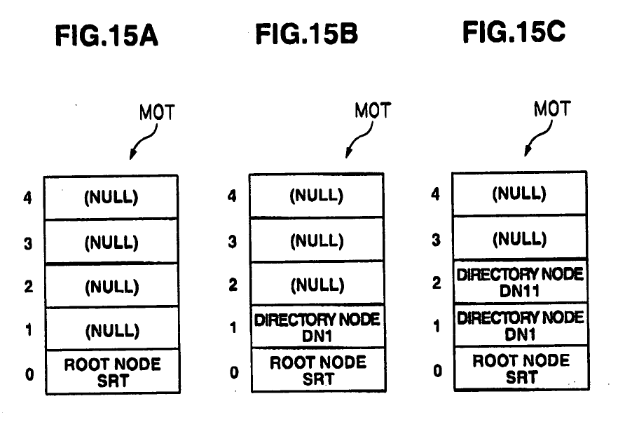

If, on the contrary, the node stored in the level 0 area in the migration path memory table MT is the root node PRT of the primary volume VOL_{P} (SP32: Yes), the CPU 31 in the disk array apparatus 4 stores the root node SRT in the node tree list SNL in a migration path temporary storage table MOT (SP34) (FIG. 15 A).

The migration path temporary storage table MOT, provided in the memory 32, is structured in the same manner as the aforementioned migration path memory table MT and stores the migration path from a root node in a switch-to volume when a node tree switching request is made.

Then, the CPU 31 in the disk array apparatus 4 reads a node stored in the area one level lower than the node that has been read from the migration path memory table MT as above (SP35). In the present example, the CPU 31 reads the directory node DN1 stored in the level 1 area in the migration path memory table MT.

Subsequently, the CPU 31 in the disk array apparatus 4 compares the node stored in the area one level lower than the node that has been read from the migration path memory table MT and node(s) in the node tree list SNL one level lower than the node stored in the table MOT (SP36). In this present example, the CPU 31 compares the directory node DN1 stored in the level 1 area in the migration path memory table MT and the directory nodes DN1 and DN2 in the node tree list SNL.

Then, the CPU 31 in the disk array apparatus 4 checks whether either of the above directory nodes DN1 and DN2 matches the node stored in the area one level lower than the node that has been read from the migration path memory table MT (SP37).

If there is a node that matches the node stored in the area one level lower than the node that has been read from the migration path memory table MT (SP37: Yes), the CPU 31 in the disk array apparatus 4 moves the node pointer NP to that node (SP38). In the present example, the CPU 31 moves the node pointer NP to the directory node DN1 in the node tree list SNL (FIG. 14 (M11)).

The CPU 31 in the disk array apparatus 4 then stores the node in the node tree list SNL that matched the node stored in the area one level lower than the node that has been read from the migration path memory table MT in the migration path temporary storage table MOT (SP39). In the present example, the CPU 31 stores the directory node DN1 in the node tree list SNL in the migration path temporary storage table MOT (FIG. 15 B).

Subsequently, the CPU 31 in the disk array apparatus 4 checks whether the node stored in the area one level lower than the node that has been read from the migration path memory table MT is the last stored node in the migration path memory table MT (SP40).

If the node stored in the area one level lower than the node that has been read from the migration path memory table MT is not the last stored node in the migration path memory table MT (SP40: No), the CPU 31 in the disk array apparatus 4 reads the node stored in the area one more level lower than the node read from the migration path memory table MT (SP35). In the present example, the directory node DN1 is not the last stored node in the migration path memory table MT, so the CPU 31 reads the directory node DN11 stored in the area one level lower than the directory node DN1 and repeats the same processing. Specifically, the CPU 31 moves the node pointer NP to the directory node DN11 in the node tree list SNL (FIG. 14 (M12)) and stores the directory node DN11 in the migration path temporary storage table MOT (FIG. 15 C).

However, if the node stored in the area one level lower than the node that has been read from the migration path memory table MT is the last stored node in the migration path memory table MT (SP40: Yes) or if no node matches the node stored in the area one level lower than the node that has been read from the migration path memory table MT (SP37: No), the CPU 31 in the disk array apparatus 4 overwrites the nodes in the migration path memory table MT (FIG. 13 C) with the nodes stored in the migration path temporary storage table MOT (SP41).

Accordingly, when the CPU 31 in the disk array apparatus 4 later receives from the information processing apparatus 2 another request to switch from the directory D11 of the node tree list SNL to the corresponding directory D11 of the node tree list PNL, it can execute the node tree switching processing as in the example described above.

Subsequently, the CPU 31 in the disk array apparatus 4 transmits to the information processing apparatus 2 the directory nodes DN111, DN112 and DN113 and the file nodes FN111, FN112 and FN113 one level lower than the directory node DN11 in the sub volume VOL_{S} (SP42).

After completing the node tree switching processing routine RT2 (SP43), the CPU 31 in the disk array apparatus 4 returns to standby mode (SP15) where it waits for another request for node information for a specified directory and its one-level-lower directory(s) and/or file(s), and repeats the same processing (SP15, SP16, RT2).

When the CPU 21 in the information processing apparatus 2 receives the node information for the directories D111n D112 and D113 and the files F111, F112 and F113 one level lower than the directory D11 in the sub volume VOL₉, it updates the display in the low level information display section 40 in the display window W₁ on the display unit 29 and displays the directories and the files (FIG. 5).

Then, the CPU 21 in the information processing apparatus 2 returns to standby mode where it waits until the directory D11 in the primary volume VOL_{P} shown on the display unit 29 is switched back to the one-level-higher directory D1 or the one-level-lower directory D111, D112 or D113 (SP13) by the user operating the operation unit 28, and repeats the same processing thereafter (SP14, SP17 to SP20, SP13).

As explained above, with the present storage system 1, simply by the user operating the operation unit 28 to switch between the recent tag 41 and the snapshot tag 42 in the directory switching section 43, it is possible to switch between the display showing the directories D111′, D112 and D114 and the files F111, F112 and F114 one level lower than the directory D11 in the primary volume VOL_{P}, and the display showing the directories D111, D112 and D113 and the files D111, F112 and F113 one level lower than the directory D11 in the sub volume VOL_{S}. Accordingly, the user can easily find such directory and/or file one level lower than the directory D11 in the primary volume VOL_{P} from the directories and files one level lower than the corresponding directory D11 in the sub volume VOL_{S}.

Moreover, with the storage system 1, the user can easily compare the directories D111′, D112 and D114 and the files F111′, F112 and F114 one level lower than the directory D11 in the primary volume VOL_{P} and the directories D111, D112 and D113 and the files D111, F112 and F113 one level lower than the directory D11 in the sub volume VOL_{S} simply by using the operation unit 28 to switch between the recent tag 41 and the snapshot tag 42 in the directory switching section 43. Accordingly, the user can easily comprehend the state of the directories and files.

### 2-1 Embodiment 2

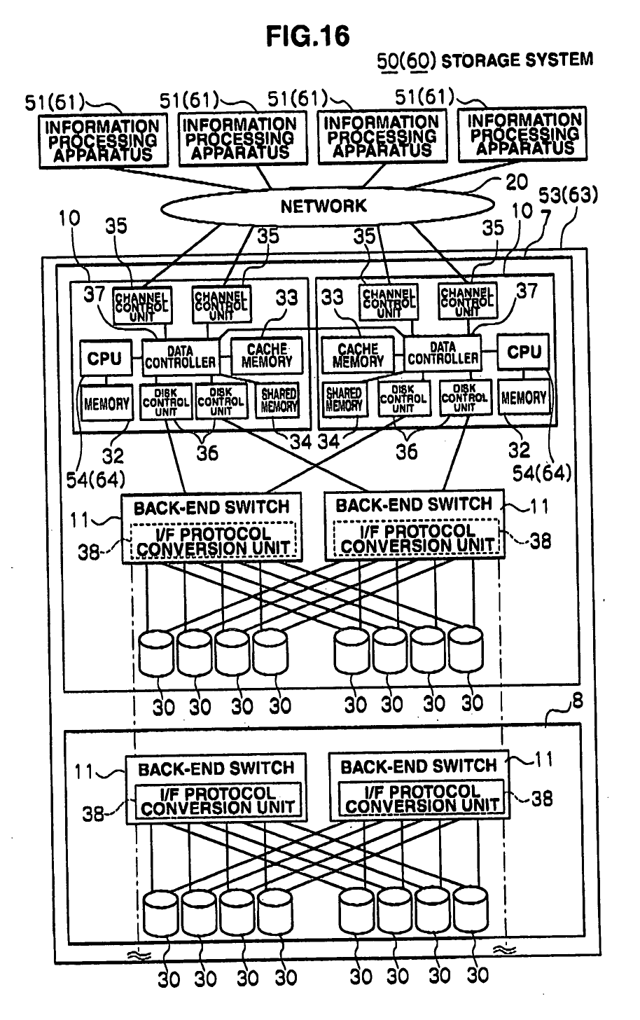

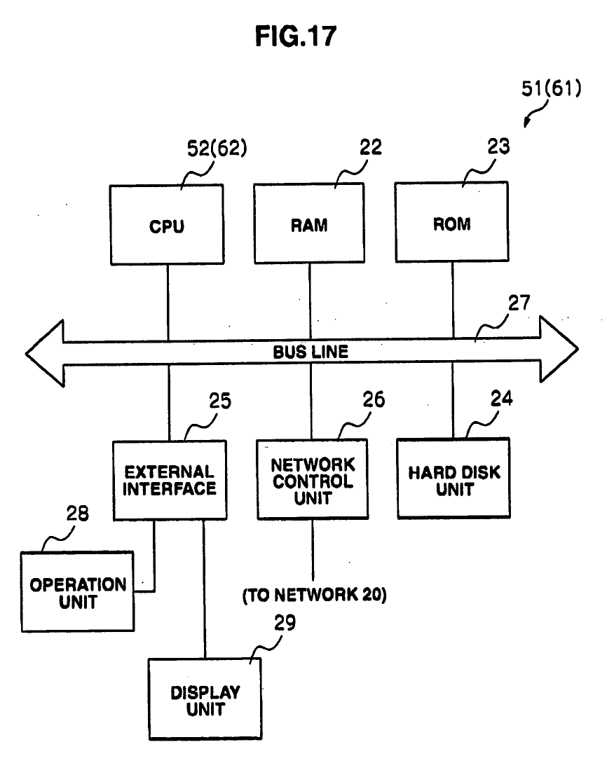

FIGS. 16 and 17, having the same reference numbers as in FIGS. 2 and 3 illustrate a storage system 50 according to Embodiment 2, which is structured in the same manner as in the storage system 1 (FIGS. 2 and 3) according to Embodiment 1 except that the processing contents executed by the CPU 52 of the information processing apparatus 51 and the CPU 54 in the disk array apparatus 53 are different.

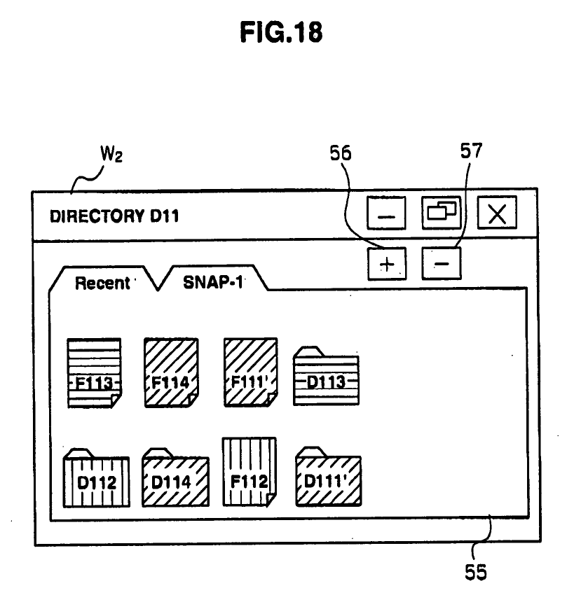

In the storage system 50, the CPU 52 in the information processing apparatus 51 displays on its display unit 29 a display window W₂ of, for example, a directory D11 as shown in FIG. 18.

The display window W₂ has: a low level information display section 55 for displaying directory(s) and/or file(s) one level lower than the directory D11 in the primary volume VOL_{P} and those one level lower than the corresponding directory D11 in the sub volume VOL_{S}, a plus button 56 to display only newly-created and updated directory(s) and/or file(s); and a minus button 57 to display only non-updated directory(s) and/or file(s).

In the display window W₂ shown in FIG. 18, neither the plus button 56 or the minus button 57 is selected and the low level information display section 55 shows the files F111′, F112, F113 and F114 and directories D111′, D112, D113 and D114. Specifically, the display window W₂ shows the state where both the recent tag 41 and the snapshot tag 42 explained in Embodiment 1 are selected.

The CPU 52 in the information processing apparatus 51 displays: the directory D113 and the file F113 that exist only in the directory D11 in the sub volume VOL_{S} (i.e., already deleted in the corresponding directory D11 in the primary volume VOL_{P}); the newly-created and updated directories D111′ and D114 and files F111′ and F114; and the non-updated directory D112 and the file F112, using different directory/file colors so that the user will not confuse them.

Accordingly, with the present storage system 50, the directories and files one level lower than the directory D in the primary volume VOL_{P} and those in the sub volume VOL_{S} are shown at the same time using different colors according to their states—newly-created, updated, or deleted—so that the user can easily comprehend the state of the directories and files.

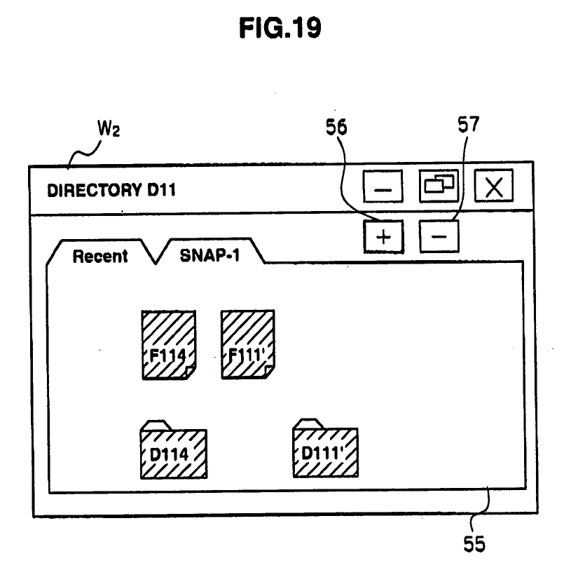

When the user selects the plus button 56 via the operation unit 28, the CPU 52 in the information processing apparatus 51 switches from the current display showing all the directories and files one level lower than the directory D11 in both the primary volume VOL_{P} and the sub volume VOL_{S} to the display showing only newly-created and updated directory(s) and/or file(s) from among them. FIG. 19 shows the state where the plus button 56 is selected and the low level information display section 55 shows the files F111′ and F114 and the directories D111′ and D114.

With the present storage system 50, simply by the user operating the operation unit 28 to select the plus button 56, newly-created and updated directory(s) and/or file(s) from among the directories and files one level lower than the directory D11 in both the primary volume VOL_{P} and the sub volume VOL_{S} can be displayed. Accordingly, the user can easily see the newly-created and updated directory(s) and file(s) one level lower than the directory D11 in both the primary volume VOL_{P} and the sub volume VOL_{S}.

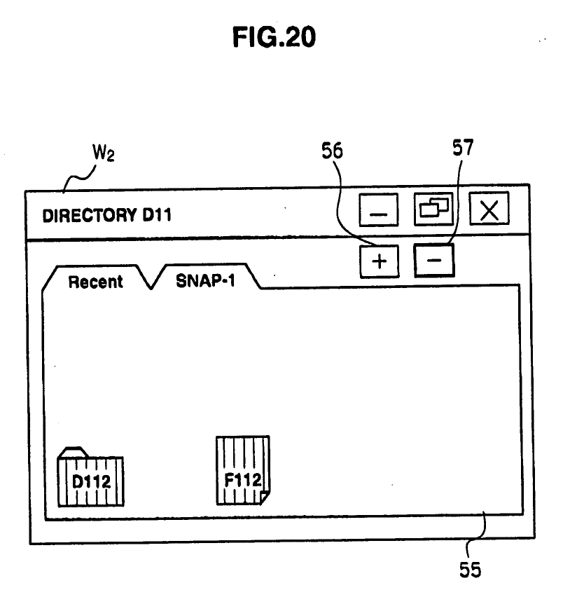

Meanwhile, when the user selects the minus button 57 via the operation unit 28, the CPU 52 in the information processing apparatus 51 switches from the current display to the display showing only non-updated directory(s) and file(s) from among the directories and/or files one level lower than the directory D11 in both the primary volume VOL_{P} and the sub volume VOL_{S}. In the present example of FIG. 20, the minus button 57 is selected and the low level information display section 55 shows the file F112 and the directory D112.

With the present storage system 50, simply by the user operating the operation unit 28 to select the minus button 57, it is possible to display only non-updated directory(s) and/or file(s) from among the directories and files one level lower than the directory D11 in both the primary volume VOL_{P} and the sub volume VOL_{S}. Accordingly the user can easily find non-updated directory(s) and file(s) one level lower than the directory D11 in both the primary volume VOL_{P} and the sub volume VOL_{S}.

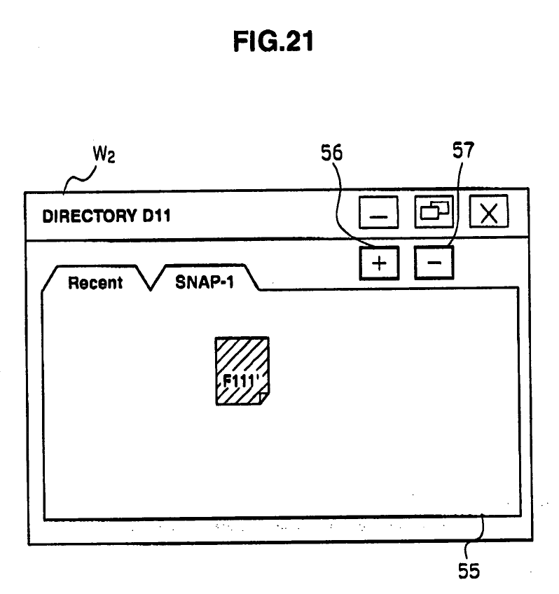

When the user selects both the plus button 56 and the minus button 57 via the operation unit 28, the CPU 52 in the information processing apparatus 51 switches from the current display to the display showing only updated directory(s) and/or file(s) from among the directories and files one level lower than the directory D11 in the both primary volume VOL_{P} and the sub volume VOL_{S}. In the example of FIG. 21, the plus button 56 and the minus button 57 are both selected and the low level information display section 55 shows the file F111′.

Consequently, with the storage system 50, simply by the user operating the operation unit 28 to select both the plus button 56 and the minus button 57, it is possible to display only updated directory(s) and/or file(s) from among the directories and files one level lower than the directory D11 in both the primary volume VOL_{P} and the sub volume VOL_{S}. Accordingly, the user can easily find updated directory(s) and/or file(s) one level lower than the directory 11 in both the primary volume VOL_{P} and the sub volume VOL_{S}.

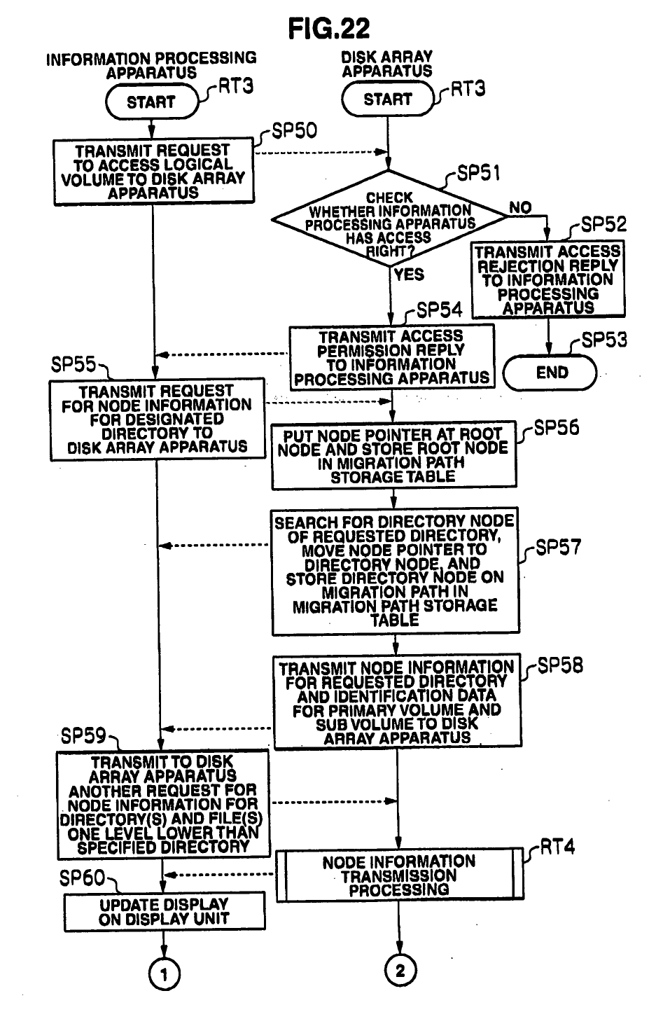

FIGS. 22 to 26 are flowcharts indicating specific processing routines for display control processing, which is conducted to control the display showing directory(s) and file(s) one level lower than a user-specified directory in one volume; and directory(s) and file(s) one level lower in the corresponding directory in the other volume at the same time.

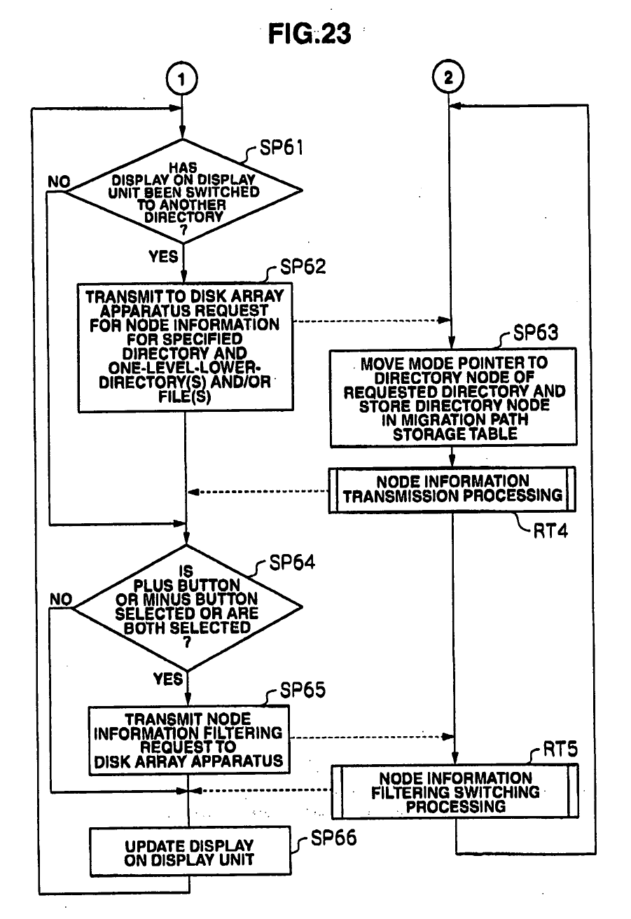

In the initial stage, the CPU 52 in the information processing apparatus 51 and the CPU 54 in the disk array apparatus 53 follow a second display control processing routine RT3 shown in FIGS. 22 and 23 and execute the same processing steps as in SP1 to SP10 in the first display control processing routine RT1 explained with reference to FIGS. 9 and 10 (SP50 to SP59).

In Embodiment 2, when the CPU 54 in the disk array apparatus 53 receives a request for nods information for directory(s) and file(s) one level lower than, for example, the directory D11 in the primary volume VOL_{P} and that of directory(s) and file(s) one level lower than the corresponding directory D11 in the sub volume VOL_{S}, it executes node information transmission processing.

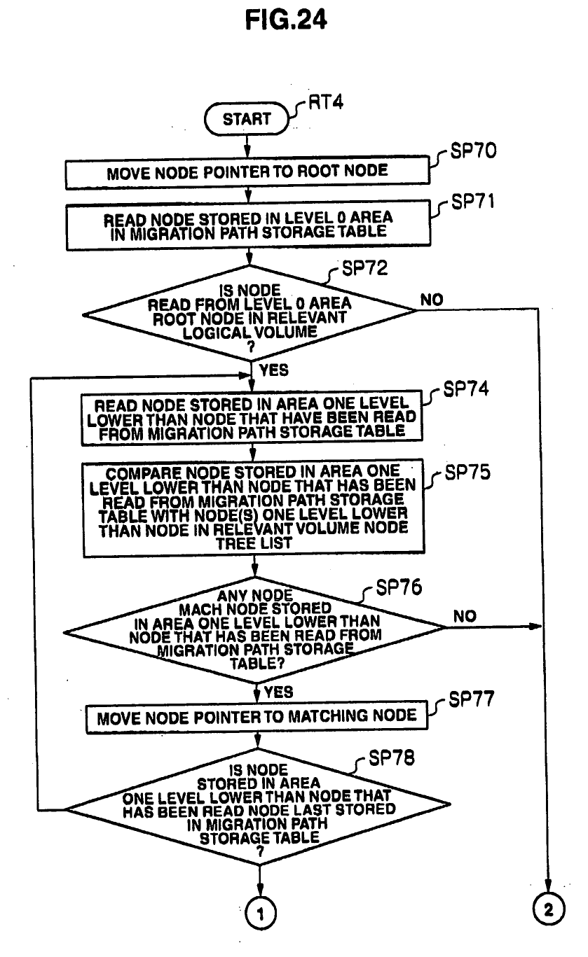

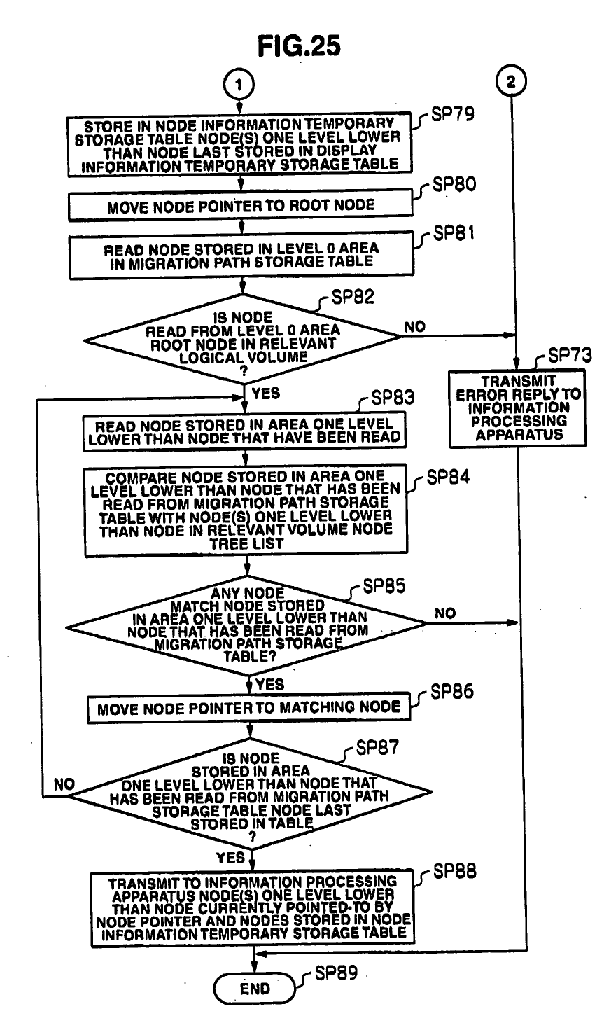

FIGS. 24 and 25 show a flowchart indicating a specific processing routine for the node information transmission processing, which is conducted to control transmission of the node information for the directory(s) and the file(s) one level lower than the directory D11 in the primary volume VOL_{P} and the sub volume VOL_{S} to the information processing apparatus 2.

The CPU 54 in the disk array apparatus 53 follows the node information transmission processing routine RT4 shown in FIGS. 24 and 25 and executes the same processing steps as the steps SP30 to SP33 in the node tree switching processing routine RT2 explained with reference to FIG. 11 (SP70 to SP73).

Subsequently, the CPU 54 in the disk array apparatus 53 executes the same processing steps as the steps SP35 to SP38 in the node tree switching processing routine RT2 explained with reference to FIG. 11 (SP74 to SP77).

Then, the CPU 54 in the disk array apparatus 53 checks whether a node stored in an area one level lower than a node that has been read from the migration path memory table MT is the last stored node in the table MT (SP78).

If the node stored in the area one level lower than the node that has been read from the migration path memory table MT is not the last stored node in the migration path memory table MT (SP78: No), the CPU 54 in the disk array apparatus 53 further reads the node stored in the area one more level lower than the node that has been read from the migration path memory table MT (SP74).

Meanwhile. If the node stored in the area one level lower than the node that has been read from the migration path memory table MT is the last stored node in the migration path memory table MT (SP78: Yes), the CPU 54 in the disk array apparatus 53 stores all nodes one level lower than the last stored node in a node information temporary storage table EOT (SP79).

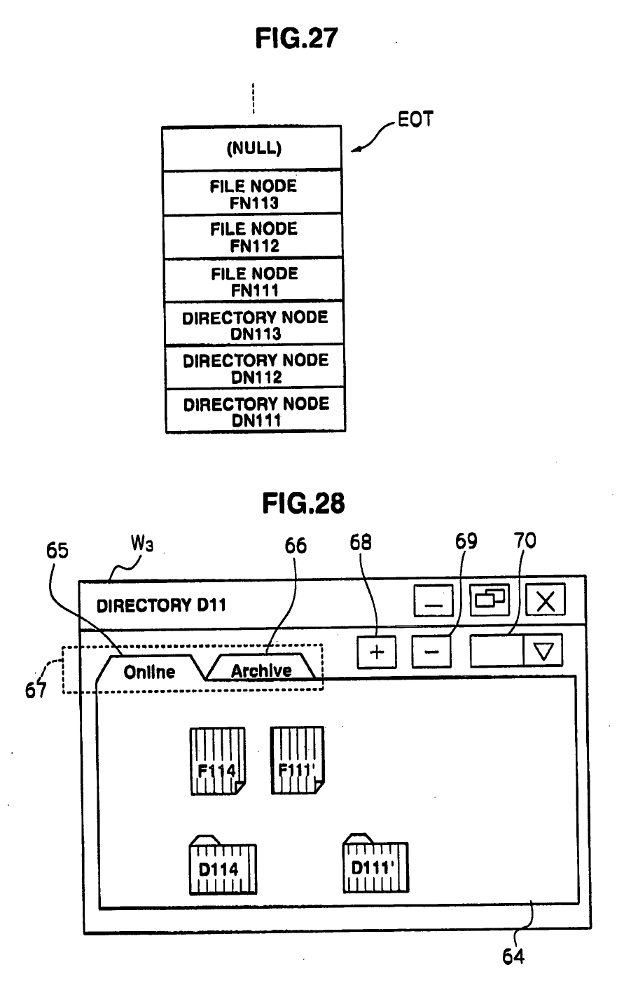

The node information temporary storage table EOT is provided in the memory 32 and configured to be able to store nodes specified by the CPU 54 in the disk array apparatus 53. In the present example, the CPU 54 stores directory nodes DN111, DN112 and DN113 and file nodes FN111, FN112 and FN113 in the node information temporary storage table EOT (FIG. 27).

Subsequently, the CPU 54 in the disk array apparatus 53 moves the node pointer NP from the currently pointed-to directory node DN11 in the node tree list SNL to the root node PRT in the node tree list PNL shown in FIG. 12 (SP80).

The CPU 54 in the disk array apparatus 53 then executes the same processing steps as the steps SP71 to SP78 explained previously (SP81 to SP87).

Then, the CPU 54 in the disk array apparatus transmits to the information processing apparatus 51 node(s) one level lower than the node currently pointed-to by the node pointer NP in the node tree list PNL and all the nodes stored in the node information temporary storage table EOT (SP88). In the present example, the CPU 54 transmits the file nodes FN111′, FN112, FN113 and FN114 and the directory nodes DN111′, DN112, DN113 and DN114 one level lower than the directory node DN11. Incidentally, it is configured so that the CPU 54 does not transmit the directory node DN111 and the file node FN111 that have not been updated yet.

The CPU 54 in the disk array apparatus 53 then terminates the node information transmission processing routine RT4 (SP89).

When the CPU 52 in the information processing apparatus 51 receives the node information for the files F111′, F112, F113 and F114 and the directories D111′, D112, D113 and D114 one level lower than the directory D11, it updates the display in the low level information display section 55 in the display window W₂ on the display unit 29, and displays the files and the directories (SP60) (FIG. 18).

Subsequently, the CPU 52 in the information processing apparatus 51 and the CPU 54 in the disk array apparatus 53 execute the same processing steps as the steps SP13 to SP15 in the aforementioned first display control processing routine RT1 explained with reference to FIGS. 9 and 10 (SP61 to SP63).

Then, the CPU 54 in the disk array apparatus 53 executes the same node information transmission processing routine RT4 as that described above with reference to FIGS. 24 and 25 (RT4).

When the CPU 52 in the information processing apparatus 51 receives the node information for the files and/or directories one level lower than a specified directory, it checks whether the plus button 56 or the minus button 57 has been selected by the user via the operation unit 28 (SP64).

If the user has selected, via the operation unit 28, the plus button 56 and/or the minus button 57 (SP64: Yes), the CPU 52 in the information processing apparatus 51 transmits a node information filtering request to the disk array apparatus 53 (SP65).

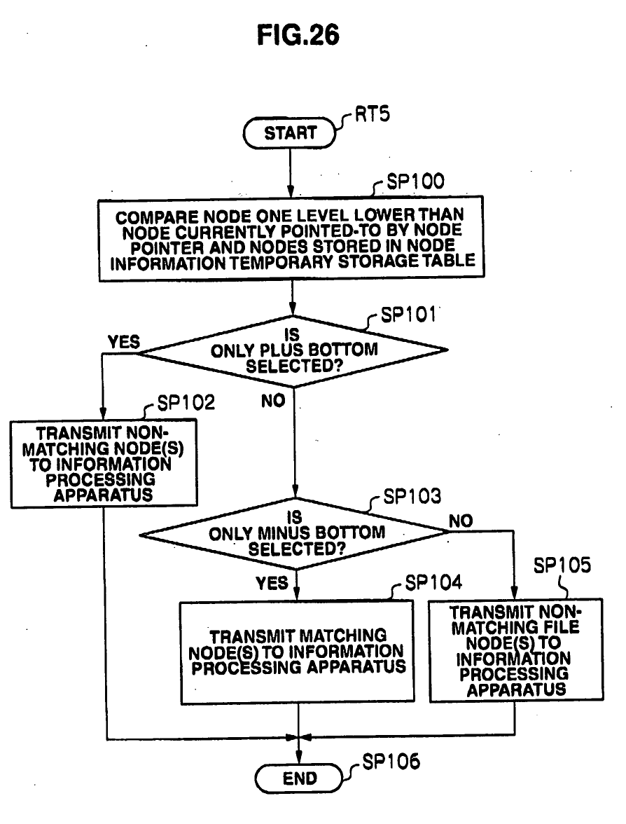

When the CPU 54 in the disk array apparatus 53 receives the node information filtering request, it executes node information filtering processing. FIG. 26 is a flowchart showing the specific processing routine for the node information filtering processing, which is conducted to control filtering of the display showing the directories and/or files one level lower than the directory D11 in the primary volume VOL_{P} and those in the sub volume VOL_{S}.

In the initial stage, the CPU 54 in the disk array apparatus 53 compares the node one level lower than the node currently pointed-to by the node pointer NP and the nodes stored in the node information temporary storage table EOT according to the node information filtering processing routine RT5 (SP100).

Subsequently, the CPU 54 in the disk array apparatus 53 checks whether only the plus button 56 is selected (SP101). If only the plus button 56 is selected (SP101: Yes), the CPU 54 compares the node one level lower than the currently pointed-to node and the nodes stored in the node information temporary storage table EOT, and transmits unmatched node(s) to the information processing apparatus 51 (SP102). In the present example, the CPU 54 transmits the file nodes FN111′ and FN114 and the directory nodes DN111′ and DN114 to the information processing apparatus 51.

If the plus button 56 is not solely selected (SP101: No), the CPU 54 in the disk array apparatus 53 checks whether the minus button 57 is solely selected (SP103).

If the minus button 57 is solely selected (SP103: Yes), the CPU 54 in the disk array apparatus 53 compares the node one level lower than the node currently pointed-to by the node pointer NP and the nodes stored in the node information temporary storage table EOT and transmits matched node(s) to the information processing apparatus 51 (SP104). In the present example, the CPU 54 transmits the file node FN112 and the directory node DN112 to the information processing apparatus 51.

Meanwhile, if the minus button 57 is not solely selected (SP103: No), it means that both the plus button 56 and the minus button 57 are selected. Therefore, the CPU 54 in the disk array apparatus 53 compares the node one level lower than the node currently pointed-to by the node pointer NP and the nodes stored in the node information temporary storage table EOT, and transmits unmatched file node(s) in the primary volume VOL_{P} to the information processing apparatus 51 (SP105). In the present example, the CPU 54 transmits the file node FN111′ to the information processing apparatus 51.

When the CPU 54 in the disk array apparatus 53 then terminates the node information filtering processing routine RT5 (SP106), it returns to standby mode where it waits for another request for node information for a specified directory and its one-level-lower directory(s) and file(s) (SP63), and repeats the same processing thereafter (RT4, RT5).

The CPU 52 in the information processing apparatus 51 updates the display in the low level information display section 55 in the display window W₂ on the display unit 29 of the information processing apparatus 51 according to the selection of the plus button 56 and/or the minus button 57 (SP66).

The CPU 52 in the information processing apparatus 51 then returns to standby mode where it waits until the display on the display unit 29 is switched from the directory D11 to the one-level-higher directory D1 or the one-level-lower directory D111′, D112 or D114 by the user via the operation unit 28 (SP61) and then repeats the same processing (SP62, SP64 to SP66, SP61).

In the present storage system 50, directory(s) and/or file(s) one level lower than the directory D11 in the primary volume VOL_{P} and that in the sub volume VOL_{S} can be displayed at the same time using different colors according to the states of the directories and files—newly-created, updated, or deleted—so the user can easily comprehend the state of the directories and/or files.

### 3-1 Embodiment 3

FIGS. 16 and 17, having the same reference numbers for corresponding parts as in FIGS. 2 and 3, indicate a storage system 60 according to Embodiment 3, which has the same structure as the storage system 1 according to Embodiment 1 (FIGS. 2 and 3) except that the contents of display control processing executed by the CPU 62 in the information processing apparatus 61 and the CPU 64 in the disk array apparatus 63 are different, and that quick-responsive, highly-reliable online hard disk drives 30 (such as Fibre Channel hard disk drives and SCSI hard disk drives) and backup-intended near line hard disk drives 30 (such as SATA hard disk drives) are used instead of using the primary volume VOL_{P} and the sub volume VOL_{S} created in the snapshot processing from the primary volume VOL_{P}.

In the present storage system 60, the CPU 62 in the information processing apparatus 61 displays on its display unit 29 a display window W₃ of a directory D11 as shown in FIG. 28.

The display window W3 has: a low level information display section 64 for displaying directory(s) and file(s) one level lower than, for example, the directory D11 in the hard disk drives 30 and those in the archive-intended hard disk drives 30; and a directory switching section 67 having an online tag 65 (Online) for selecting the directory D11 in the online hard disk drives 30 and an archive tag 66 (Archive) for selecting the corresponding directory D11 in the archive hard disk drives 30. In the display window W₃ shown in FIG. 28, the online tag 65 is selected and the low level information display section 64 shows files F111′ and F114 and directories D111′ and D114.

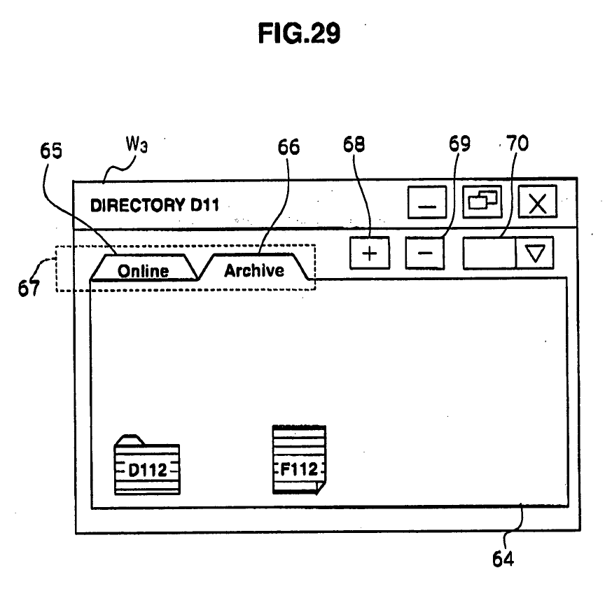

When the user selects the archive tag 66 via the operation unit 28, the CPU 62 in the information processing apparatus 61 switches from the display showing the directory D11 in the online hard disk drives 30 to the display showing the directory D11 in the archive hard disk drives 30, as shown in FIG. 29.

In the display window W₃ in FIG. 29, the archive tag 66 is selected and the low level information display section 64 displays a file F112 and a directory D112.

As is clear from FIGS. 28 and 29, the CPU 62 in the information processing apparatus 61 shows the directory D11 in the online hard disk drives 30 and the directory D11 in the archive hard disk drives 30 using different directory/file colors so that the user will not confuse them.

In addition, when the user selects the archive tag 66 via the operation unit 28 after selecting a directory and/or a file one level lower than the directory D11 in the online hard disk drives 30, the CPU 62 in the information processing apparatus 61 migrates the selected directory and/or file from the online hard disk drives 30 to the archive hard disk drives 30.

Moreover, when the user selects the online tag 65 via the operation unit 28 after selecting a directory and/or a file in the archive hard disk drives 30, the CPU 62 in the information processing apparatus 61 migrates the selected directory and/or file from the archive hard disk drives 30 to the online hard disk drives 30.

As described previously, in the storage system 60, simply by the user switching between the online tag 65 and the archive tag 66 in the directory switching section 67 after selecting a directory and/or a file, it becomes possible to migrate a specific directory and/or a file one level lower than the directory D11 in the online hard disk drives 30 to the archive hard disk drives 30, or migrate a specific directory and/or a file one level lower than the directory D11 in the archive hard disk drives 30 to the online hard disk drives 30.

Moreover, in the present storage system 60, simply by switching between the online tag 65 and the archive tag 66 in the directory switching section 67 after selecting a directory and/or file through the operation unit 28, the user can easily perceive whether or not the directory and/or file in the directory D11 in the hard disk drives 30 and that in the archive hard disk drives 30 has been migrated.

Embodiment 3 has been explained regarding the case where the directory D11 in the online hard disk drives 30 and the directory D11 in the archive hard disk drives 30 are displayed in different colors, however the present invention is not limited that case, and other identification methods can be employed, for example, the low level information display sections 64 may be displayed in different colors between the online hard disk drives 30 and the archive hard disk drives 30.

Furthermore, when the user selects, via the operation unit 28, the directory and/or file that has been migrated from the online hard disk drives 30 to the archive hard disk drives 30 and thereafter selects the online tag 65, the CPU 62 in the information processing apparatus 61 again migrates the selected directory and/or file from the directory D11 in the archive hard disk drives 30 back to the directory D11 in the online hard disk drives 30.

The CPU 62 in the information processing apparatus 61 may also be provided with a plus button 68 for migrating directory(s) and/or file(s) one level lower than the directory D11 in the online hard disk drives 30 to the archive hard disk drives 30; and a minus button 69 for migrating directory(s) and/or file(s) one level lower than the directory D11 in the archive hard disk drives 30 to the online hard disk drives 30.

Moreover, the CPU 62 in the information processing apparatus 61 may display director(s) and/or file(s) one level lower than the directory D11 in the online hard disk drives 30 and that in the archive hard disk drives 30 at the same time in the low level information display section 64 as in the case of Embodiment 2.

When the above system is adopted, the storage system 60 may have a pull down menu 70 or the like for switching the functions of the buttons.

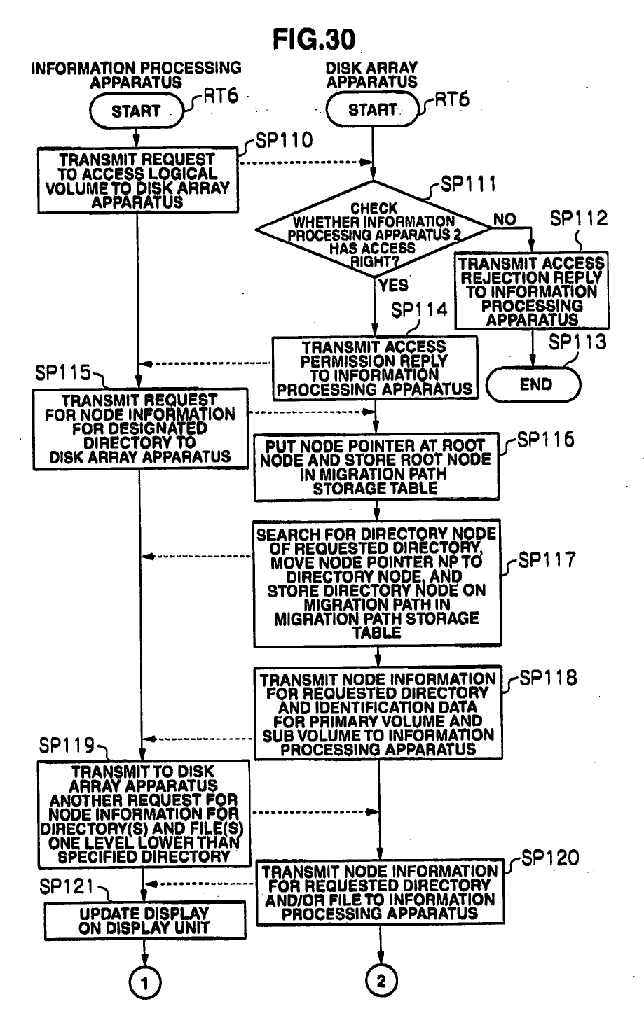

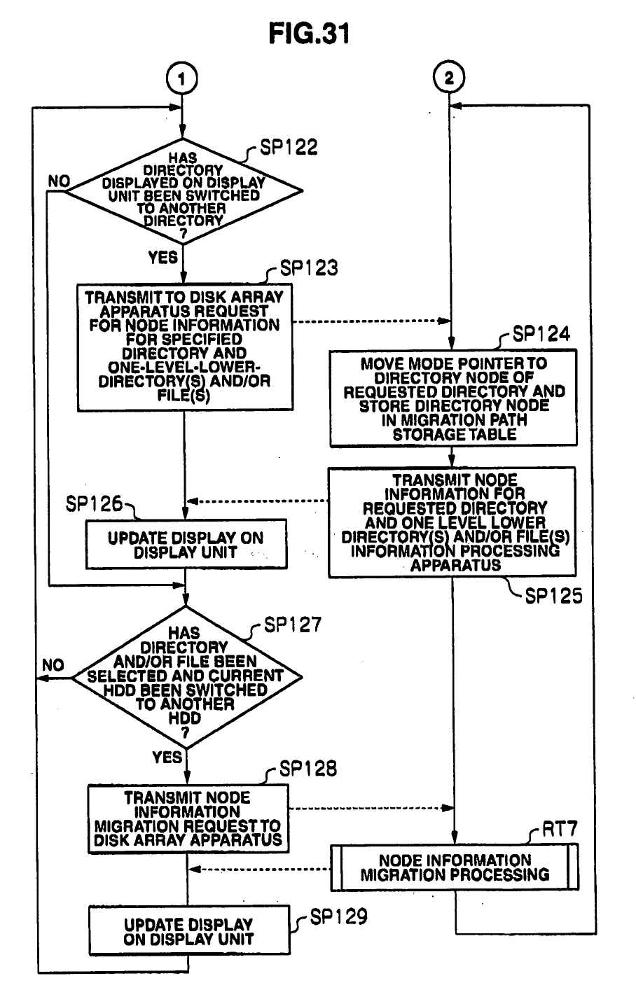

FIGS. 30 to 32 are flowcharts indicating specific processing routines for display control processing, which is conducted to control migration of a selected directory and/or file by the user via the operation unit 28.

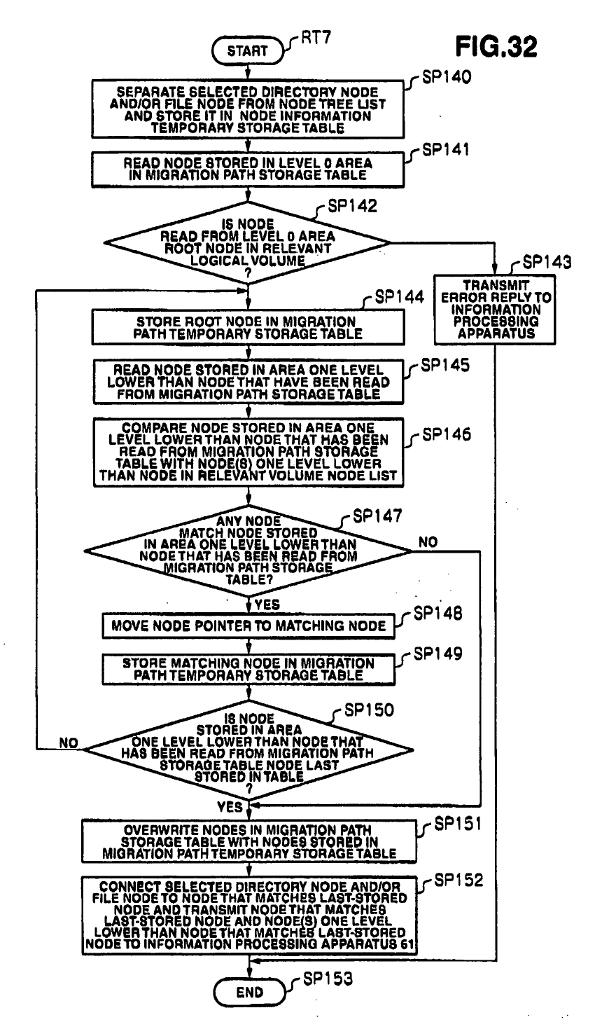

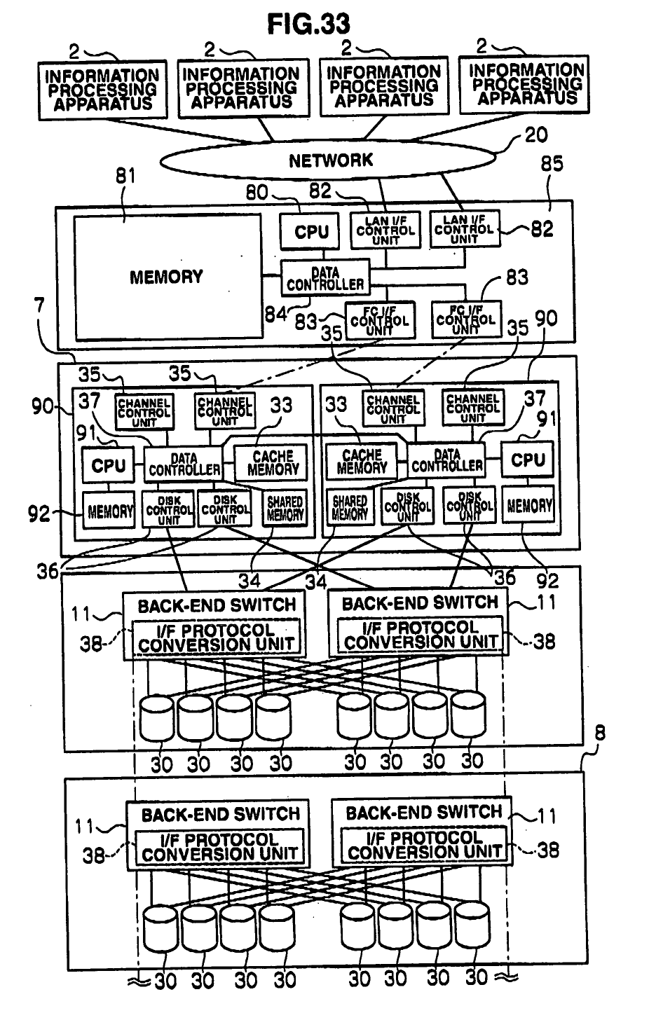

The CPU 62 in the information processing apparatus 61 and the CPU 64 in the disk array apparatus 63 execute the same processing steps as the steps SP1 to SP17 in the display switching processing routine RT1 explained with reference to FIGS. 9 and 10, according to a third display control routine RT6 shown in FIGS. 32 and 33 (SP110 to SP126).

Subsequently, the CPU 62 in the information processing apparatus 61 waits until the user selects, via the operation unit 28, a directory and/or file one level lower than a specified directory and switches from the current hard disk drives 30 to the other hard disk drives 30 (SP127). When the user later selects a directory and/or a file one level lower than a specified directory and switches from the current hard disk drives 30 to the other hard disk drives 30, the CPU 62 in the information processing apparatus 61 transmits a request to migrate node information for the selected directory and/or file to the disk array apparatus 63 (SP128).

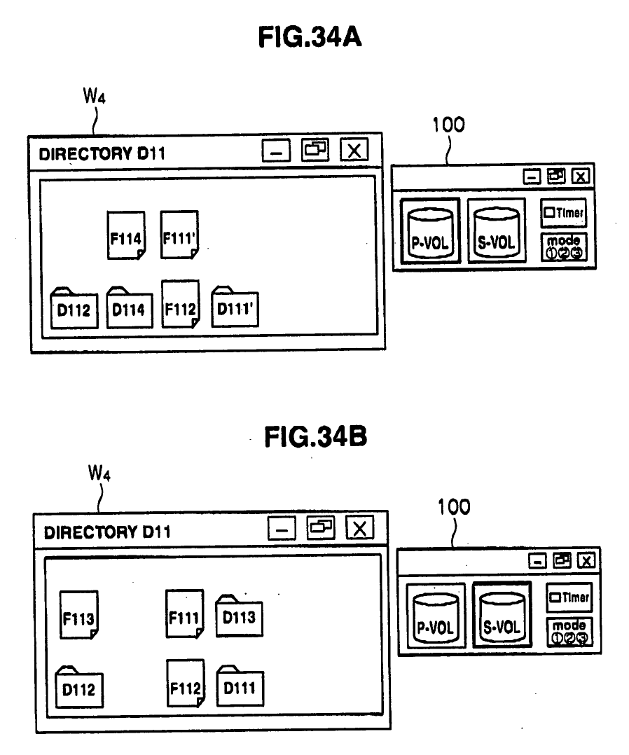

When the CPU 64 in the disk array apparatus 63 receives that request from the information processing apparatus 61, it executes directory/file migration processing. Specifically, the CPU 64 in the disk array apparatus 63 separates the selected directory node and/or file node from the node tree list and stores it in the node information temporary storage table according to a directory/file migration processing routine RT7 shown in FIG. 34 (SP140).

The CPU 64 in the disk array apparatus 63 then executes the same processing steps as the steps SP30 to SP41 in the first display switching processing routine RT1 explained with reference to FIG. 11 (SP141 to SP151).

The CPU 64 in the disk array apparatus 63 then reads the directory node(s) and/or file node(s) stored in the node information temporary storage table EOT, connects it(them) to a node that matches a last stored node in the migration path storage table EOT, migrates the selected file to the corresponding hard disk drives 30, and transmits the node that matched the last stored node and the node(s) one level lower than the node that matched the last stored node to the information processing apparatus 61 (SP152).

When the CPU 64 in the disk array apparatus 63 then completes the directory/file migration processing routine RT7 (SP153), it returns to standby mode where it waits for a request for node information for directory(s) and file(s) one level lower than a specified directory (SP124) and repeats the same processing (SP125, RT7, SP124).

The CPU 64 in the disk array apparatus 63 then updates the display in the low level information display section 64 in the display window W₃ on the display unit 29 in the information processing apparatus 61 based on the selection of a directory and/or file (SP129).

The CPU 64 in the disk array apparatus 63 then returns to standby mode where it waits until the user switches the display on the display unit 29 from the currently-displayed directory to its one-level-higher directory or one-level-lower directory (SP122) and then repeats the same processing (SP123, SP126 to SP128, SP129, SP121).

As described, with the present storage system 60, simply by the user switching between the online tag 65 and the archive tag 66 in the directory switching section 67 after selecting a directory and/or a file, it becomes possible to migrate a specific directory and/or file one level lower than the selected directory D11 in the online hard disk drives 30 to the archive hard disk drives 30, or migrate a specific directory and/or file one level lower than the selected directory D11 in the archive disk drives 30 to the online hard disk drives 30.

### 4 Other Embodiments

The present invention has been explained so far regarding the case where the primary volume VOL_{P} and the sub volume VOL_{S} created in the snapshot processing from the primary volume VOL_{P} are used and the case where quick-responsive, highly reliable online hard disk drives 30 (such as Fibre Channel disk drives and SCSI hard disk drives) and backup-intended near line hard disk drives 30 (such as SATA hard disk drives) are used. However, the present invention is not limited to these cases and it can be applied to other cases, for example, the case where all file data in the primary volume VOL_{P} is copied to create volume(s) to be stored in the sub volume VOL_{S} or the case where a pair structure is established between original and replication volumes. In these cases, the states of directories and/or files in sub volumes VOL_{S} or replication volumes—updated or non-updated—can be distinguished based on titles and time stamps.

The present invention has also been explained regarding the case where the recent tag 41 and the snapshot tag 42 are provided, however, the present invention is not limited to that case, and those tags can be replaced with radio buttons or pull down menus for switching the display on the display unit.

Moreover, the present invention has been explained regarding the case where the NAS controller is integrated with the basic chassis 7 of the disk array apparatus 4, however the present invention is not limited to that case and a NAS controller 85 having a CPU 80, memory 81, LAN interface control unit 82, FC interface control unit 83 and a data controller 84 may be provided separately from the basic chassis 7 of the disk array apparatus 4 so that the disk controller 90 having a CPU 91 and a memory 92 does not serve as a NAS controller.

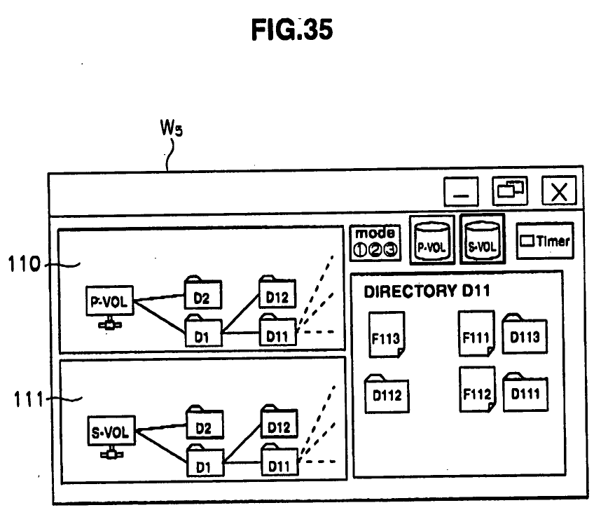

The present invention has also been explained regarding the case where a display window W₁ is displayed having the recent tag 41 and the snapshot tag 42 as shown in FIG. 4, however, the present invention is not limited to that case and other display methods may be employed, for example, a directory switching section 100 may be provided in a separate window from the display window W₄ as shown in FIG. 34 A and B, or it is possible to display a primary volume VOL_{P} node tree list 110 and a sub volume VOL_{S} node tree list 111 in a display window W₅ as shown in FIG. 35.

According to the present invention, it is also possible to set a schedule—dates and times—in the disk array apparatus so that nodes are switched from one to another for a specified information processing apparatus based on the schedule. With this system, even if the disk array apparatus runs twenty four hours without stopping, it can execute normal operations in daytime and a migration path storing unit for storing directory nodes of each level from a first root node to the first directory node in the first node tree, the directory nodes being on the migration path; and processing at night time according to the schedule. Then, when backup software in the specified information processing apparatus executes backup processing, the disk array apparatus switches the volume from the current node to a specified node set in the schedule. Accordingly, simply by setting a specified volume, for example, a normal-use volume, in the backup software, backup from sub the volume can be conducted without changing the settings in the backup software.

In conventional methods, when restoring normal-use volumes upon trouble, it is necessary to change the data-restoring-destination from a sub volume to a primary volume. However, in the present invention, when backup software in the specified information processing apparatus executes backup processing, the disk array apparatus switches the volumes from a current node to a node set in the schedule so that backup can be conducted without changing the settings in the backup software.

Moreover, even if the backup-mode setting in the backup software is full-backup mode setting where the backup target is all data, data to be backed up can be specified by applying Embodiment 2.

With the present disk array apparatus, it is possible to change, upon setting a schedule, a ratio of bandwidths for data transfer and/or requirement of cache resources according to time schedules, thereby enabling look-ahead reading of data, and backup time can be reduced. Switching of necessary bandwidths may be conducted based on QOS parameters so that a predetermined bandwidth can be ensured and an internal command queue depth can be tuned.

Furthermore, according to the present invention, the disk array apparatus can be assumed as a virtual tape library apparatus (VTLA) which is based on a LAN interface. In a VTLA, a plurality of IP addresses can be set for one port. Therefore, when the VTLA is designated by a first IP address, it may respond to a tape library command and when it is designated by a second IP address, it may respond to a NAS command. Incidentally, a response to a tape library command is limited to reading only, therefore, changing of files or the like cannot be conducted.

In order to support backup, backup application operating in an information processing apparatus transmits, upon full backup, a node tree list to the VTLA and specifies the position of data to be transferred based on the node tree list.

Likewise, upon difference backup, a node tree list including location of specified files is transferred from the backup application to the VTLA. The VTLA compares the transferred node tree list and node tree lists that have been received earlier and sets a common point. The node tree list may be collected by the VTLA. This system can be realized by analyzing transfer formats in the backup application. Specifically, the VTLA analyzes write target data received immediately after a write command having a file mark and counts separator letters in the obtained path/file name, thereby perceiving the level of current data.

When the VTLA is designated by the second IP address, it executes the volume switching processing as above based on the oldest-date node tree list or the latest-date node tree list. The embodiments of the present invention have been described regarding the case where the switching processing can be conducted even when conducting difference backup. However, it can be conducted only for full backup. In the latter case, almost similar to the aforementioned snapshot processing, the VTLA specifies a selected directory or file by searching the oldest-date node tree list and transfers the data from its storage address to the information processing apparatus according to a NAS protocol. In this case, updating files and writing new files is not permitted.

The present invention can be widely applied to storage systems in various forms.

What is claimed is:

1. A storage system having a host system and a storage apparatus, the storage apparatus including a first volume and a second volume to store files transmitted from the host system,
wherein the host system comprises:
a display unit for displaying the content of a first directory in the first volume and the content of a corresponding second directory in the second volume; and
a switching unit for switching between the display showing the content of the first directory and the display showing the content of the second directory on the display unit,
wherein the storage apparatus further comprises:
a searching unit for searching for the second directory based on a table having a migration path from a root directory to the first directory in the first volume stored therein; and
a transmitting unit for transmitting the content of the second directory, which is searched for by the searching unit, to the host system.

2. The storage system according to claim 1 wherein the second volume is a snapshot volume of the first volume.

3. The storage system according to claim 1 wherein the second volume is a replication volume of the first volume.

4. The storage system according to claim 1,
wherein the transmitting unit in the storage apparatus transmits an identifier for the first volume and an identifier for the second volume to the host system,
wherein the switching unit in the host system switches between the content of the first directory and that of the second directory based on the identifiers for the first and second volumes transmitted from the transmitting unit of the storage apparatus.

5. The storage system according to claim 1,
wherein the storage apparatus has a comparing unit for comparing the content of the first directory and the content of the second volume,
wherein the transmitting unit transmits only specified content of the first directory and specified content of the second directory based on the comparison made by the comparing unit,
wherein the display unit in the host system concurrently displays the specified content of the first directory and the specified content of the second directory, transmitted from the transmitting unit in the storage apparatus.

6. The storage system according to claim 1,
wherein the searching unit in the storage apparatus searches for the second directory based on the table when switching is externally performed via the switching unit.

7. The storage system according to claim 1,
wherein the searching unit in the storage apparatus searches for the second directory based on the table at a predetermined timing.

8. The storage system according to claim 1,
wherein the display unit in the host system displays the content of the first directory and the content of the second directory in such a manner that a user can distinguish between them.

9. The storage system according to claim 5,
wherein the host system comprises:
a selecting unit for selecting specified content in the first directory and specified content in the second directory; and
a transmitting unit for transmitting the content selected via the selecting unit to the storage apparatus,
wherein the comparing unit in the storage apparatus compares the content of the first directory and the content of the second volume based on the selection content transmitted from the transmitting unit of the host system.

10. The storage system according to claim 1,
wherein, when the second directory is not found, the searching unit in the storage apparatus searches for a directory having the same path as in the table.

11. A storage apparatus having a first volume and a second volume to store files transmitted from a host system, the storage apparatus comprising:
a searching unit for searching for a second directory based on a table having a migration path from a root directory to a first directory in the first volume stored therein; and
a transmitting unit for transmitting the content of the second directory searched for by the searching unit to the host system.

12. The storage apparatus according to claim 11,
wherein the second volume is a snapshot volume of the first volume.

13. The storage apparatus according to claim 11,
wherein the second volume is a replication volume of the first volume.

14. The storage apparatus according to claim 11,
wherein the transmitting unit transmits an identifier for the first volume and an identifier for the second volume to the host system.

15. The storage apparatus according to claim 11 further comprising a comparing unit for comparing the content of the first directory and that of the second volume,
wherein the transmitting unit transmits only specified content in the first directory and specified content in the second directory based on the comparison made by the comparing unit.

16. The storage apparatus according to claim 11,
wherein the searching unit searches for the second directory based on the migration path storage table when switching is externally performed via the switching unit.

17. The storage apparatus according to claim 11,
wherein the searching unit searches for the second directory based on the migration path storage table at a predetermined timing.

18. The storage apparatus according to claim 15,
wherein the comparing unit compares the content of the first directory and that of the second volume based on the selection content transmitted from the host system.

19. The storage apparatus according to claim 11,
wherein when the second directory is not found, the searching unit searches for a directory having the same path as stored in the migration path storage table.

20. A storage system having a host system and a storage apparatus, the storage apparatus including a first volume and a second volume to store files transmitted from the host system,
wherein the host system comprises:
a display unit for displaying a third directory and/or a first file one level lower than a first directory in the first volume, or, a fourth directory and/or a second file one level lower than a second directory in the second volume, the third directory corresponding to the first directory; and
a switching section shown on the display unit for switching from the display showing the third directory and/or the first file one level lower than the first directory to the display showing the fourth directory and/or the second file one level lower than the second directory,
wherein the storage apparatus comprises:
a managing unit for managing a first node tree where file nodes for the files and directory nodes for the directories in the first volume are arranged in a hierarchy tree; and a second node tree where file nodes and directory nodes in the second volume are arranged in a hierarchy tree;
a migration path storing unit for storing directory nodes of each level from a first root node to the first directory node in the first node tree, the directory nodes being on the migration path; and
a control unit by which, when switching is performed externally via the switching section displayed on the display unit, a third directory node is searched for in the second node tree based on the directory nodes stored in the migration path storing unit and a fourth directory node and/or second file node one level lower than the third directory node are transmitted to the host system.
